(19) United States
(12) Patent Application Publication
(10) Pub. No.: US 2025/0181684 A1
(43) Pub. Date: Jun. 5, 2025

(54) HOW TO SUPPORT AN OTP SERVICE BY VERIFYING A USER BY USING A PERSONAL URL MEDIA, A PASSWORD OR OTHER INFORMATION

(71) Applicant: Geum-Cheol KIM, Dongan-Gu, Anyang-Si Gyeonggi-do (KR)

(72) Inventor: Geum-Cheol KIM, Gyeonggi-do (KR)

(21) Appl. No.: 17/776,756

(22) PCT Filed: Nov. 11, 2020
(86) PCT No.: PCT/KR2020/015738

§ 371 Date: May 13, 2022

(30) Foreign Application Priority Data
Nov. 12, 2019 (KR) 10-2019-0144584

(51) Int. Cl. G06F 21/31

(52) U.S. Cl. CPC G06F 21/31

(57) ABSTRACT

The present invention can provide the OTP service capable of using an OTP user ID, the OTP system capable of registering OTP user devices, the OTP for login purpose, the OTP for transaction purpose (the transaction OTP, the 2ndOTP) capable of being registered in an OTP system, or other means.

The OTP system capable of identifying a user by using a personal URL medium, other devices or other information can set an OTP user ID, set SS login information by using OTP login information, or register a 2ndOTP medium.

In order to log into a SS (=service system, service server), an OTP-AS (=OTP authentication server) authenticates the OTP login information including the OTP/ID generated by the PS/OTP-GS (=Personal Server/OTP Generation Server) capable of identifying a user by using a personal URL medium, other devices, or other information, and in order to support the transaction of the SS, the OTP-AS authenticates the 2ndOTP/ID information including the 2ndOTP of a 2ndOTP generator.

In order to log into a SS (=service system, service server), the OTP-AS (=OTP authentication server) authenticates the OTP login information including the OTP/ID generated by the PS/OTP-GS capable of identifying a user by using a personal URL medium, other devices, or other information, and in order to support the transaction of the SS, the OTP-AS authenticates the 2ndOTP/ID information including the 2ndOTP generated by the PS/OTP-GS capable of identifying the user by using a 2ndOTP URL medium, other devices, or other information.

### TECHNICAL FIELD

The OTP service that can support logging in a service system (=a service server), the transaction of the service system, or other services.

### DISCUSSION OF RELATED ART

(An OTP: A one-time password) An OTP is a one-time password. A password is remembered by humans, but an OTP is generated by an OTP generator. A password is distinguished by the ID of a person who remembers it, but an OTP generator is distinguished by the fact that a user possessed and logged in.

(An OTP generation method) An OTP generation method includes a time synchronization method, an event synchronization method, or other methods. a) A time synchronous method: This generates an OTP by using time information as a parameter. Time information of OTP generator and time information of an OTP authentication server must match. b) An event synchronous method: This generates an OTP by using an event as parameter. An event of OTP generator and an event of OTP authentication server must match.

(Types and characteristics of an OTP generator) a) The current OTP generator includes an OTP hardware generator (=an OTP hardware Token), an OTP software generator, and an OTP hybrid generator. b) (Characteristic 1) Since an OTP is individual's secret information, there is currently only an OTP generator in the form possessed by an individual. c) (Characteristic 2) The current OTP generator only provides an OTP and cannot provide an OTP user ID. In the present, what owning an OTP generator means the OTP user using the OTP generator.

(An OTP hardware generator, an hardware OTP) a) An OTP hardware generator is the device that generates an OTP based on hardware without interworking with an external device. b) (The KR 10-1413971) This patent's OTP generator generates an OTP and transmits it to an authentication terminal (a terminal capable of transmitting an OTP to an OTP authentication server through an intermediary server) through NFC communication. c) (U.S. Ser. No. 10/645,077 B2) This patent's OTP generator (USB Token, Physical Token) generates an OTP and delivers it to a user.

(An OTP software generator, a mobile OTP) a) An OTP software generator generates an OTP based on software without interworking with an external device. An OTP software generator is installed in a terminal and works. b) (U.S. Ser. No. 10/645,077 B2) This patent's OTP software generator (an Software Token) generates an OTP and delivers it to a user. c) (The Google OTP) The Google OTP app generates an OTP and delivers it to a user.

(An OTP hybrid generator, a smart OTP) a) An OTP hybrid generator is the system which two or more devices work together to generate an OTP. b) (The KR 10-2014-0131201) The smart card of this patent (including the OTP generation function) generates an OTP by receiving seed information (time information, transaction information, MAC), etc. from a terminal. c) (The KR 10-2015-0020514) The security module (including the OTP generation function) of the mobile terminal of this patent receives security information from a security card and generates an OTP. d) (The KR 10-1626942) The OTP-only application (including the OTP generation function for a transaction) of the terminal of this patent receives the OTP from an OTP card (including the OTP generation function) and generates a transaction OTP. e) (The KR 10-1028882) In this patent, an OTP generation application (including the OTP generation function) of a portable terminal generates an OTP (response value) in response to the trial value received from an OTP server and transmits it to an OTP server. f) (The JP [symbol] 6032626 [symbol] ) In this patent, a NFC authentication card (including an OTP generation function) generates an OTP by receiving time information and transaction information from an authentication app of a wireless terminal device.

(Problems of the current OTP generator or the OTP current service) a) There is the validity date due to loss, replacement, hacking, or other problems. b) Due to the validity period or finiteness of use, it cannot be used for a login purpose, but only used for a transaction or a login auxiliary purpose. c) Structurally or realistically, it cannot be used for a login purpose. A login requires at least two pieces of information (an ID and a password), but the current OTP generator provides only OTP, so it cannot be structurally used for a login purpose. In order to log in a service system by linking with an OTP generator and an ID set by a user, the OTP generator must be registered in the service system through a complex procedure. By the way, due to the possibility of reissuance of an OTP generator and a complex registration procedure of an OTP generator, an OTP generator cannot be used for a login purpose in reality. d) It cannot be used for a login purpose because it is fundamentally difficult to prevent an illegal use. Because an ID is not secretive and can be inferred, it is fundamentally difficult to prevent an illegal login using a lost OTP generator. e) It must be periodically reissued, and each time it is issued, it must be registered in all service systems to use a service. Therefore, the current OTP generators have the limited use area. f) It cannot be used for a login purpose because lifetime use cannot be guaranteed. Lifetime use of an OTP generator cannot be guaranteed because an OTP generator is the device that generates a password and there is the possibility of loss. g) The service system or a terminal must manage the information related to an OTP generator. Currently, the service system or a terminal manages the SN (serial number) of an OTP generator or secret information for the OTP generator. h) Since a service system must match a user's ID with the SN of an OTP generator, the service system cannot use an OTP by using a passage (a role of transmitting information to the outside). Currently, a service system checks login information by itself, and confirms a transaction OTP by using a partial passage (a service system performs some operations on its own and transmits information to the outside for other operations). i) It cannot provide the means supporting an OTP multi-authentication (authenticating two or more linked OTPs) j) Since a user possesses an OTP generator, there is a possibility that an OTP algorithm can be leaked. k) It cannot support an overseas service system and cannot support the global business of a service system. 1) An OTP generator should be replaced periodically. An OTP generator must be replaced periodically due to a time error, a battery problem, a terminal problem, or other problems. m) The scope of use is limited and a service structure is closed. A service system selects an OTP system but a user cannot select an OTP system.

(Advantages of an OTP) a) Because it is disposable, it is impossible to use it illegally even if exposed. b) There is no need to store passwords in a terminal, a service system, or other devices.

(Disadvantages of an OTP) a) It requires an OTP generator. b) ‘Problems of the current OTP generator or an OTP current service’ mentioned above are cited.

(A purpose of an OTP) Currently, the purpose of an OTP is a transaction purpose or a login auxiliary purpose, but there is no a login purpose.

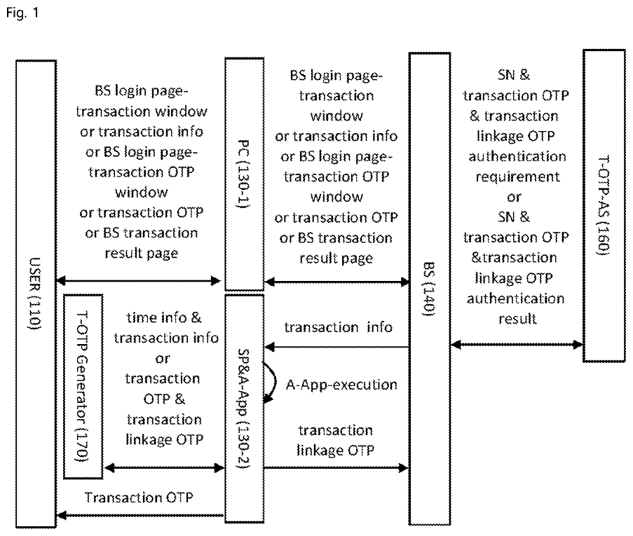

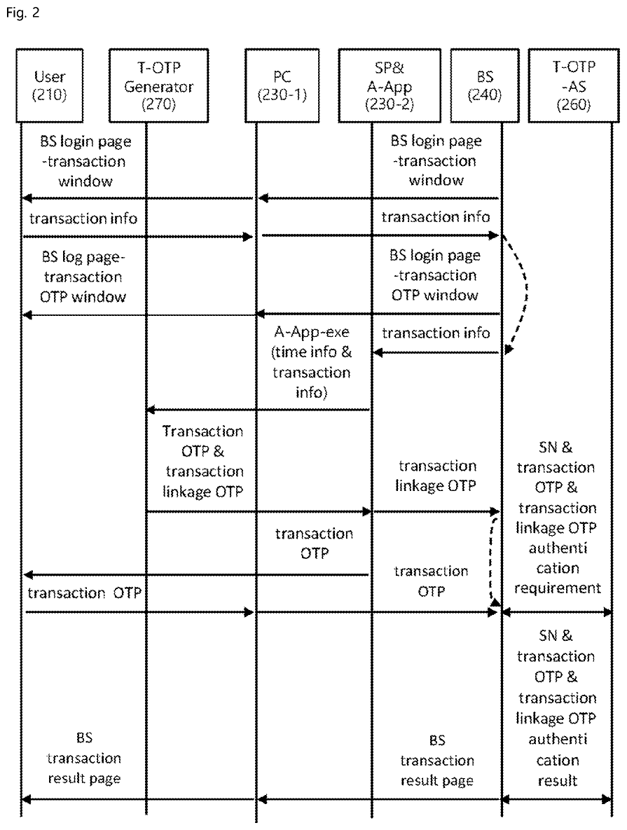

(A transaction OTP, a T-OTP) a) A transaction OTP is the OTP that supports a transaction (account transfer, payment, or other transactions). b) (Evidence 1: JP 6032626) The evidence of JP 6032626 is “step of receiving the OTP number and the transaction linkage OTP number generated by the NFC authentication card 50 by the authentication application 42” of claim 1 of, etc. See FIGS. 1 and 2 of the specification of the present invention. c) (Evidence 2: The KR 10-2014-0131201) The evidence of the KR 10-2014-0131201 is “OTP capable of verifying forgery, falsification of transaction information and preventing transaction denial” in the summary, etc. d) (Evidence 3: The KR 10-2015-0020514) The evidence of the KR 10-2015-0020514 is “a secure OTP number generation system using the secure card with NFC function, characterized in that it includes the secure module that performs the OTP function for safe financial transactions” of claim 2, etc. e) (Evidence 4: The KR 10-1626942) The evidence of the KR 10-1626942 is “Generate OTP for transaction by using the PIN, OTP and time value as input (INPUT)” of claim 1, etc. f) (Evidence 5: The KR 10-2017-0142358) The evidence of the KR 10-2017-0142358 is “When a verification requirement for the OTP number is received from the financial service using terminal or the user terminal through the transaction relay server, performing verification and transmitting the verification result to the financial server, automatic transmission-based smart OTP service comprising the steps of: method of provision”, etc.

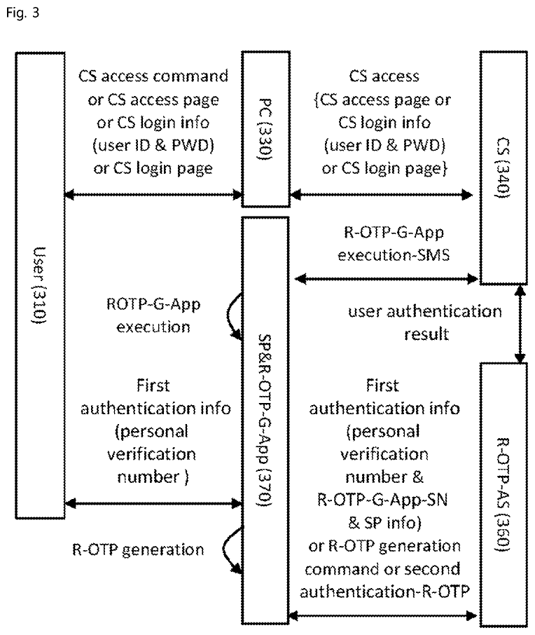

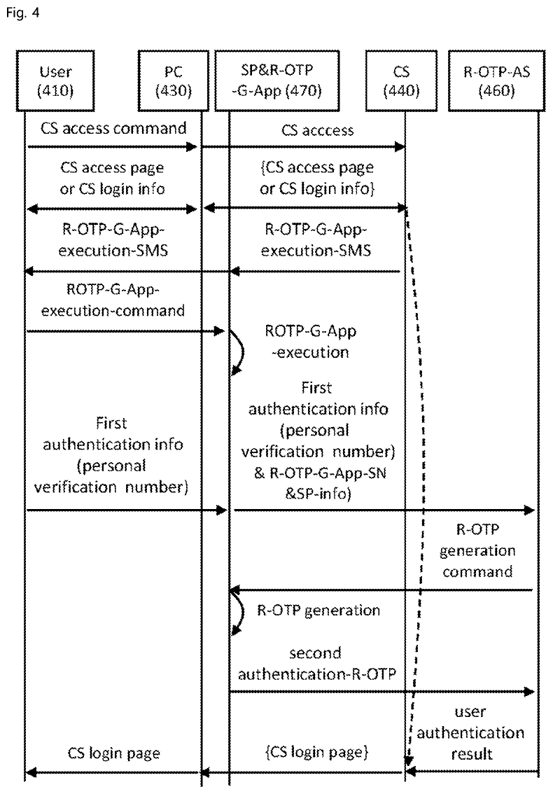

(A login secondary OTP, a LS-OTP) a) A login secondary OTP (=LS-OTP) is the OTP used as a second password to support login information. In the method of using a login secondary OTP, a service system authenticates login information by itself firstly, and an OTP system authenticates a login secondary OTP secondly. b) (Evidence 1: KR 10-1028882) The evidence of KR 10-1028882 is “When login information is received from the user PC, the connection server (=CS) that delivers the callback URL SMS for running the OTP generation application to the user's mobile terminal corresponding to the received login information” of claim 1, etc. First, the CS authenticates the CS login information, and secondly, the R-OTP-AS authenticates the OTP (Secondary Authentication-R-OTP) (refer to FIGS. 3 and 4). c) (Evidence 2: U.S. Ser. No. 10/645,077 B2) The evidence of U.S. Ser. No. 10/645,077 B2 is “One common form of multi-factor authentication is two-factor authentication in which the first factor is the user password and the second factor is a one-time password (OTP) generated by a generator OTP in possession of the user.” of paragraph [0005], “The OTP provides the extra layer of security in addition to the user password” of paragraph [0063], other contents. The computer first authenticates the user password and secondly authenticates the OTP. d) (Evidence 3: the Google OTP) The Google OTP is used as the second password to assist login. To log in the service system by using Google OTP, a user ID and a password and a Google OTP (second password) must be used. First, the service system authenticates a user ID and a password, and secondly, the OTP system authenticates a Google OTP.

(An OTP for login, a login OTP, an L-OTP) a) A login OTP (=OTP for login, or L-OTP) is the OTP used as the first login password. b) (Current situation) Currently, there is no an login OTP.

(Currently, Why there is no a login OTP) a) It cannot be used for a login purpose because it is fundamentally difficult to prevent a fraudulent use. Since an ID is not secretive and can be inferred, it is fundamentally difficult to prevent an illegal login by using a lost OTP generator. b) It cannot be used for a login purpose because the current OTP generator has an expiration date, cannot guarantee a lifetime use, and must be reissued. An OTP generator, such as a password combining with a user ID, is registered in a service system through the process equivalent to a membership registration. A reissued OTP generator can be used after a registration. For users, it is very inconvenient to register the reissued OTP generator in the same way as membership registration.

### <Existing Patent Analysis 1: The Patent Using a Transaction OTP>

(Components of JP 6032626: refer to FIGS. 1 and 2) a) (About FIGS. 1 and 2) FIGS. 1 and 2 are prepared to easily compare the ‘JP 6032626’ with the present invention. Since FIGS. 1 and 2 do not represent everything of JP 6032626, the inventive step of the present invention should not be judged by the contents of FIGS. 1 and 2. b) (Overview and operation) The JP 6032626 is about the transaction OTP. A BS runs the authentication app with transaction information received from a user. The authentication app receives the transaction OTP and the transaction linkage OTP from a T-OTP generator and the transaction OTP is delivered to the user and the transaction linkage OTP to the BS. The BS delivers the transaction OTP's the SN, the transaction OTP received through a PC, and the transaction linkage OTP received from the authentication app to an authentication server (a T-OTP-AS). The T-OTP-AS delivers the SN & transaction OTP & transaction linkage OTP authentication result that authenticated the SN, the transaction OTP, and the transaction linkage OTP to the BS. The BS supports transactions with the SN & transaction OTP & transaction linkage OTP authentication results, and delivers a BS transaction result page to the PC. The PC delivers a BS transaction result page to the user. c) (A T-OTP generator: A transaction OTP generator) This is “NFC authentication card 50”. This generates the transaction OTP and the transaction linkage OTP and sends it to the authentication app. d) (Problem 1 of the T-OTP generator) The SN of the T-OTP generator must be registered in the BS, and the OTP and SN must match (verify) for authentication (refer to claim 5 of the JP 6032626). Whenever the T-OTP generator is issued, the SN must be registered in all service systems to be used. e) (Problem 2 of the T-OTP Generator) Since the T-OTP generator cannot be guaranteed for lifetime use due to the possibility of loss it cannot be used for login purpose. f) (Smart phone & Authentication App=SP&A-App) This is “a wireless terminal (40) in which an authentication application is installed”. g) (The authentication app=A-App) This is the app that assists the T-OTP generator without generating the OTP. It delivers time information & transaction information to the T-OTP generator, and the transaction OTP and transaction linkage OTP received from the T-OTP generator to the user and BS. h) (BS) This is “bank server (20)”. It manages the SN of the T-OTP generator, matches the SN with the OTP (the transaction OTP and transaction linkage OTP), and delivers the SN and OTP to the T-OTP-AS. i) (Problems of the BS) Whenever the OTP is authenticated, the BS must match the SN with the OTP. The BS must store and manage the SN. The BS must register a new SN whenever the T-OTP generator is issued. j) (The T-OTP-AS: The T-OTP Authentication Server) This is the “authentication server (30)”. This authenticates the SN and OTP (the transaction OTP and transaction linkage OTP) received from the BS and delivers the SN & transaction OTP & transaction linkage OTP authentication result to the BS. k) (Problem 1 of the T-OTP-AS) The T-OTP-AS cannot solve problems of having to register the OTP generator in the service system whenever the OTP generator is issued. 1) (Problem 2 of the T-OTP-AS) The T-OTP-AS cannot authenticate the OTP for login purpose.

(Operating elements of JP 6032626: refer to drawings 1 and 2) a) (A BS login page) This is the web page after the BS decides to log in. b) (Transaction information) This is transaction information (transfer information, payment information, or others). c) (The transaction window) This is the window that can support transactions. d) (A BS login page-transaction window) This is the BS login page including the transaction window. e) (The transaction OTP, the transaction linkage OTP) The transaction OTP and transaction linkage OTP are OTPs that can support transactions. f) (A transaction OTP window) This is the window that can support thing related to the transaction OTP (excluding transaction linkage OTP). g) (A BS login page-transaction OTP window) This is the BS login page including the transaction OTP window. h) (The SN) This is the serial number of the T-OTP generator (evidence: claim 5). The SN is used as information that matches the T-OTP generator and the user whenever the OTP is authenticated. The SN must be registered in the service system whenever the OTP generator is issued. i) (The SN & transaction OTP & transaction linkage OTP authentication requirement) This is for the BS to request authentication for the SN, the transaction OTP, and the transaction linkage OTP. j) (The SN & transaction OTP & transaction linkage OTP authentication result) This is the result of authenticating the SN, the transaction OTP, and the transaction linkage OTP. k) (A BS transaction result page) This is the web page containing the results of the BS supporting transactions using the transaction information and the SN & transaction OTP & transaction linkage OTP authentication result.

### <Existing Patent Analysis 2: The Patent Using a Login Secondary OTP>

(Components of KR 10-1028882: refer to drawings 3 and 4) a) (Regarding FIGS. 3 and 4) FIGS. 3 and 4 are prepared to easily compare “KR 10-1028882” with the present invention. FIGS. 3 and 4 do not represent all of KR 10-1028882, so the inventive step should not be judged by the contents of FIGS. 3 and 4. b) (Overview) KR 10-1028882 is the invention using a login secondary OTP. c) (Evidence 1 of login secondary OTP) “the connection server that receives login information from the user PC and delivers the CallBack URL SMS for running the OTP generation application to the user's mobile terminal corresponding to the received login information (refer to the first half of claim 1) that” is evidence. The connection server (CS) first authenticates the user by using the login information received from the user, and secondly delivers the SMS to the user's mobile phone to run the OTP generation application. d) (Evidence 2 of the login secondary OTP) “User authentication system of OTP method that uses the portable terminal including the OTP server that transmits the user authentication result to the connection server (refer to the second half of claim 1)” is evidence. The connection server receives the user authentication result (not the transaction result) from the OTP authentication server (the R-OTP-AS), finally authenticates the user and decides to log in. e) (The login secondary OTP) In the above Evidences 1 and 2, after the connection server first authenticates the user with the login information, the connection server receives the authentication result (the user authentication result) of the OTP authentication server (the R-OTP-AS) secondly, and finally authenticates the user to determine the login do. Therefore, the OTP of the KR 10-1028882 is the login secondary OTP. f) (The SN: unique verification number, serial number) The “unique verification number” of “OTP-generated application unique verification number” is the SN. The OTP authentication server (the R-OTP-AS) of the KR 10-1028882 delivers the user authentication result, which is the result of matching and authenticating the SN (the SN of the R-OTP generating app) and an OTP (second authentication-R-OTP), to the CS. g) (Operation) The CS first authenticates the user with the CS login information (user ID & password) received from the user and sends the SMS to the SP&R-OTP-G-App (=Smart phone & R-OTP generation App) to run the R-OTP-G-App (OTP generating application). The user runs the R-OTP generating app (=R-OTP-G-APP) in response to the SMS and delivers the personal verification number to the R-OTP-G-APP. The R-OTP-G-APP delivers the first authentication information (personal verification number, R-OTP generating app SN (=R-OTP-G-APP SN) and smart phone information (=SP information)) to the R-OTP-AS. The R-OTP-AS verifies the first authentication information and transmits the R-OTP generation command to the R-OTP generation App. The R-OTP generation App delivers the OTP (second authentication-R-OTP) to the R-OTP-AS. R-OTP-AS authenticates the second authentication-R-OTP and delivers the user authentication result to CS. The CS finally authenticates the user in response to the user authentication result and determines the login. h) (R-OTP generating App=R-OTP-G-APP) This is an “OTP generation application”. “R” means the response value. i) (Problem 1 of the R-OTP generation App) The R-OTP generation App must be installed on the smart phone. Apps are always at risk of being hacked. j) (Problem 2 of the R-OTP generation App) The R-OTP generation App is used after the CS verifies the user with login information and cannot be used for the login because there is the possibility of it being lost. k) (Problem 3 of R-OTP generation App) R-OTP generation App can generate OTP only when SN, personal verification number and smart phone number are authenticated. 1) (Problem 4 of the R-OTP generation App) If the smart phone is lost or replaced, the R-OTP generation App must be reinstalled, and the R-OTP-AS and the R-OTP generation App must match the SN again. m) (Problem 5 of R-OTP generation App) Users must install R-OTP generation App as many as the number of service systems they want to use. n) (CS) This is “connection server (300)”. o) (Problem of CS) CS must match login information and mobile phone information and send SMS text message. p) (R-OTP-AS) This is “OTP server (400)”. The R-OTP-AS proceeds to authenticate the OTP in two steps (the step of verifying the first authentication information and the step of authenticating the second authentication-R-OTP). R-OTP-AS delivers the user authentication result to CS. q) (Problems of R-OTP-AS) R-OTP-AS must manage personal verification number, SN, and smart phone information. r) (R-OTP generation App) This is the App that is installed in the mobile terminal (200) and generates the OTP. s) (Problem 1 of R-OTP generation App) R-OTP generation App cannot support OTP for login because there is the possibility of being hacked or lost. t) (Problem 2 of the R-OTP generation App) The user must remember the personal verification number to use the R-OTP generation App. If smart phone is lost, personal verification number may be leaked.

(Operation elements of KR 10-1028882: refer to drawings 3 and 4) a) (CS login information) This is the “login information” in claim 1. b) (R-OTP) This is the “response value (OTP)” of FIG. 1 of KR 10-1028882. “R” means the response value. The R-OTP is OTP that supports CS login information. c) (R-OTP generation App execution-SMS=R-OTP-G-APP execution-SMS) This is the SMS including the command of “run R-OTP generation App”. d) (Personal Verification Number) This is remembrance information that identifies the user of the R-OTP generation App. e) (First authentication information) This is the “personal verification number and OTP generation application unique verification number (R-OTP generation App SN) and mobile terminal information (smart phone information)” (refer to claim 4). f) (R-OTP generation command) This is the “to run the OTP generation application after user authentication in the OTP server” (refer to claim 4). This is to instruct the R-OTP-AS to generate an OTP (second authentication-R-OTP) with the R-OTP generating app after verifying the user with the first authentication information. g) (Second authentication-R-OTP) This is the “step (c) of transferring the generated response value to the OTP server” (refer to claim 5). The R-OTP generating app generates OTP (second authentication-R-OTP, response value) and delivers it to the R-OTP-AS. h) (User authentication result) This is the “user authentication result” (refer to claim 1). This is login second information used to determine login by CS firstly authenticating login information (CS login information) and then secondarily authenticating OTP (second authentication-R-OTP).

(“serial number of JP 6032626”, “serial number of the KR 10-1028882”, “serial number of Google OTP”) Whenever the BS of “JP 6032626” requests the authentication of the OTP for transaction, it transmits the “serial number of the T-OTP generator” to the OTP authentication server (T-OTP-AS). The OTP generating app (R-OTP generation App) of the KR 10-1028882 delivers the “serial number of the R-OTP generating app” to the authentication server (R-OTP-AS) to authenticate the OTP for login auxiliary (second authentication-R-OTP). The smart phone with Google OTP installed transmits the “Google OTP serial number” to the Google authentication server to authenticate the OTP for login assistance (Google OTP).

(A SN and an OTP authentication) An existing OTP authentication server authenticates an OTP by matching a SN and the OTP of an OTP generator.

(A SN matching vs an ID matching) In the past, an OTP was authenticated by matching an OTP generator's SN and an OTP (a SN matching). Currently, there is no an ID matching that authenticates an OTP by matching an OTP user ID with an OTP.

### SUMMARY

a) (An OTP user ID setting) It provides the OTP system that can set an OTP user's ID (an OTP user ID) of an OTP user. The current OTP generator does not use an OTP user's ID.

b) (An OTP login information setting) It provides the OTP system that can support the SS capable of setting login information by using an OTP user ID, an OTP, or other information. The SS can set OTP login information as login information. The current OTP cannot be used for a login, but are used for a transaction or login assistance.

c) (A 2ndOTP medium registration) It provides the means capable of registering a OTP user device (a 2nd OTP generator or a 2nd OTP URL medium) of transaction purpose in the external devices (a PS/OTP-GS or an OTP-AS or other devices) of a SS. The current OTP generator (It's for transaction purpose) is registered in a SS (A serial number (=SN) is stored in a SS).

d) (More secure generation system) It provides the OTP system capable of generating an OTP or information related an OTP by checking a user more safely and conveniently. An OTP system can generate an OTP/ID, a 2ndOTP/ID, or other information by verifying a user more safely and conveniently by using a URL (a personal URL or a 2ndOTP URL), a password (a URL password or a 2ndOTP URL password), or other information. Currently, an OTP generator generates only an OTP and only the possessor of an OTP generator can use an OTP.

e) (Lifelong use) It provides the OTP generator (=PS/OTP-GS) that can be used for a lifelong. Since a PS/OTP-GS is the server without the possibility of loss and the loss of an OTP user device (2ndOTP medium) does not affect a SS, the PS/OTP-GS can be used for a lifetime. The current OTP generator (the OTP generation part of the KR 10-1413971, the OTP generator of the U.S. Ser. No. 10/645,077 B2, the smart card of the KR 10-2014-0131201, the security module of the KR 10-2015-0020514, the OTP-only application of the KR 10-1626942, or the OTP generation application of the KR 10-1028882) cannot be used for a lifetime because it is likely to be lost and the loss of the OTP generator affects a SS.

f) (Method determining a login) It provides the OTP system that can determine a SS login by using login information including an OTP. A SS delivers OTP login information to an OTP system and can determine a login by using an authentication result of the OTP system.

g) (Passage) It provides the means for a SS to determine a login by operating as a passage (the passage means passing information to the outside of a SS). A SS can deliver OTP login information to an OTP system, receive an authentication result of an OTP system, and determine a login. However, the current SS authenticates login information by itself.

h) (A transaction OTP matched with an ID) It provides the OTP system capable of supporting a SS that trade by using the transaction OTP matched with an OTP user ID. An OTP system can deliver the authentication result of 2ndOTP/ID information to a SS to support a SS's transaction. The current SS trades by using the transaction OTP matched with a serial number.

i) (A system generating a 2ndOTP/ID) It provides the OTP system that can generate the transaction OTP (the 2ndOTP) matched with an OTP user ID. The current OTP generator generates the transaction OTP matched with a serial number.

j) (An OTP multi-authentication) It provides the OTP system that can support an OTP multi-authentication. An OTP system can support the OTP multi-authentication capable of authenticating OTP login information for a SS's login and capable of authenticating 2ndOTP/ID information for a SS's transaction. Currently, there is no the OTP multi-authentication.

k) (A Global business) It provides the OTP system capable of supporting a global business. The OTP user ID including an OTP system ID can connect a SS and an OTP system worldwide. Since the SN of the current OTP generator does not include an OTP system ID, it cannot connect a SS and an OTP system worldwide.

l) (Preventing the leakage of an OTP algorithm) It provides the OTP system that is difficult for the OTP algorithm to leak. Since a PS/OTP-GS cannot be lost, an OTP algorithm is difficult to leak. However, since the current OTP generator can be lost, the current OTP algorithm can be leaked.

m) (Preventing the illegal use of an OTP algorithm) It provides the OTP system that can economically prevent the illegal use of a leaked OTP algorithm. It can prevent an illegal use by using the method changing an OTP algorithm by interworking a PS/OTP-GS and an OTP-AS. However, at present, an OTP algorithm cannot be changed because an OTP generator and an authentication server cannot be interworked.

n) (Intermediary information) It provides the OTP system that can economically match intermediary information. A PS/OTP-GS and an OTP-AS can be interworked in order to economically match intermediary information. However, since the current OTP generator and the current authentication server cannot be interworked, it cannot economically match intermediary information.

o) (An additional service) It provides the OTP system that can manage user information or provide the user information to a SS or other system. A PS/OTP-GS or an OTP-AS can manage user information and deliver it to a SS or other systems. However, the current OTP-AS does not manage user information and deliver it to the SSs or other systems.

p) (Low cost) It provides the OTP system that has lower manufacturing or operating cost. Since a PS/OTP-GS is a server, the overall manufacturing or operating cost can be lowered. However, at present, since the OTP generator is possessed by a user, the overall manufacturing or operating cost is high.

q) (Creation of added values) It provides the OTP system that can create added values. A PS/OTP-GS can create added values by using the advertisements or other information of web pages. However, at present, it is difficult to include advertisements or other information because a user possesses an OTP generator.

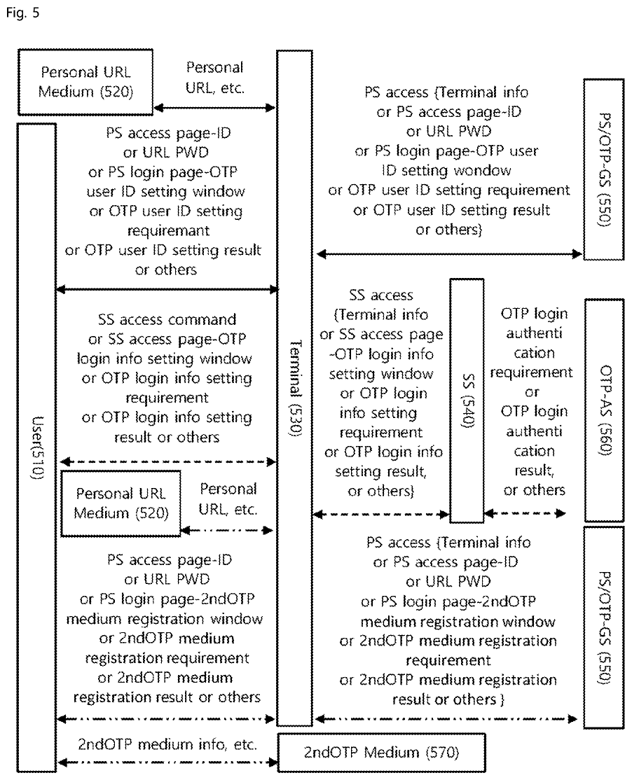

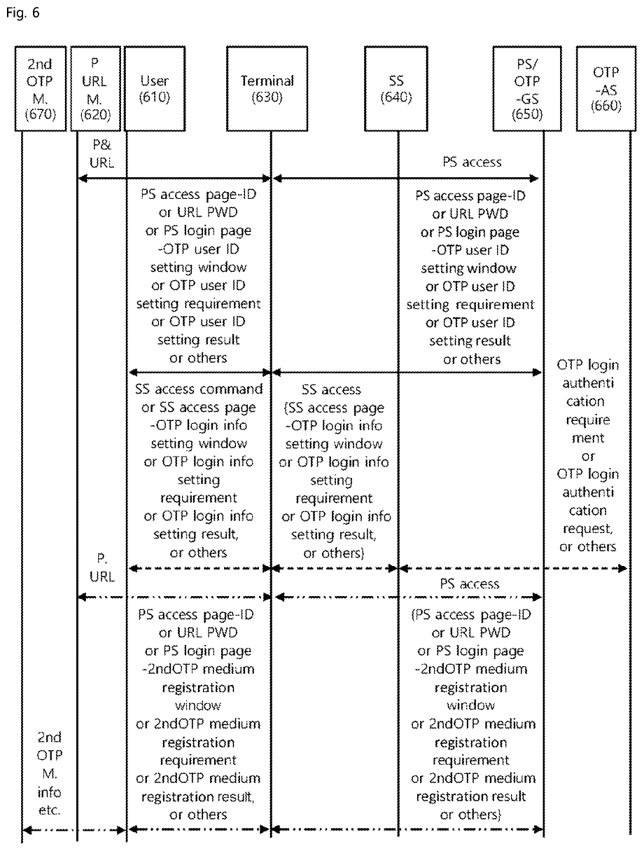

(1. An OTP user ID setting means, refer to the solid line arrows in FIGS. 5 and 6) A user, a personal URL medium, a terminal, a PS/OTP-GS, a personal URL, terminal information, a PS access page-ID, a URL password, a PS login page-OTP user ID setting window, an OTP user ID setting requirement, an OTP user ID setting result, or other elements works organically to set an OTP user ID.

(2. An OTP login information setting means, refer to the dotted arrows in FIGS. 5 and 6) A user, a terminal, a SS, an OTP-AS, a SS access command, a SS access page-OTP login information setting window, an OTP login information setting requirement, an OTP login authentication requirement, an OTP login authentication result, an OTP login information setting result, or other elements works organically to set OTP login information.

(3. A 2ndOTP medium registration means, refer to the double-dotted line arrows in FIGS. 5 and 6) A user, a personal URL medium, a terminal, a PS/OTP-GS, a 2ndOTP medium, a personal URL, terminal information, a PS access page-ID, a URL password, a PS login page-2ndOTP medium registration window, a 2ndOTP medium registration requirement, 2ndOTP medium information, a 2ndOTP medium registration result, or other elements works organically to register the 2ndOTP medium in an OTP system.

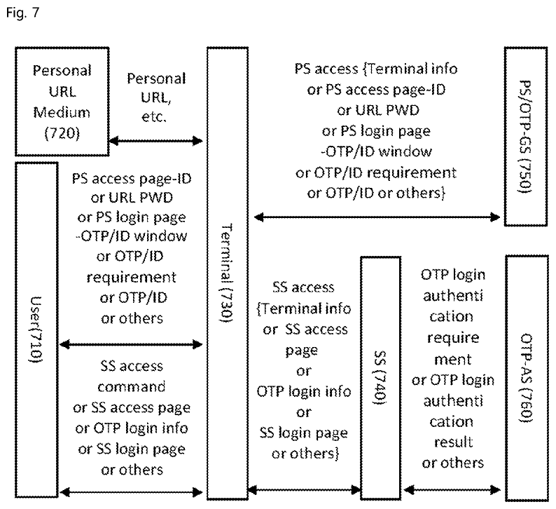

(4. An OTP login means, refer to FIGS. 7 to 10) A user, a personal URL medium, a terminal, a SS, a PS/OTP-GS, an OTP-AS, a personal URL, terminal information, a PS access page-ID, a URL password, a PS login page-OTP/ID window & SS list window, an OTP/ID requirement, a SS selection, PS information, an OTP/ID, a SS access command, a SS access page, OTP login information, an OTP login authentication requirement, an OTP login authentication result, a SS login page, or other elements works organically to log in the SS by using the OTP login information.

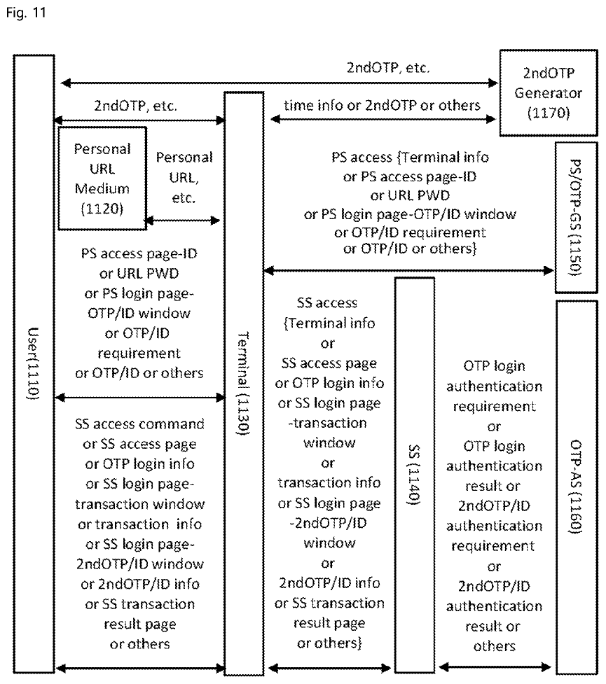

(5. An OTP login & 2ndOTP transaction means, refer to FIGS. 11 to 14) A user, a personal URL medium, a terminal, a SS, a PS/OTP-GS, an OTP-AS, a 2ndOTP generator, a personal URL, terminal information, a PS access page-ID, a URL password, a PS login page-OTP/ID window & SS list window OTP/ID requirement, a SS selection, PS information, an OTP/ID, a SS access command, a SS access page, OTP login information, an OTP login authentication requirement, an OTP login authentication result, a SS login page-transaction window, transaction information, a SS login page-2ndOTP/ID window, 2ndOTP, 2ndOTP/ID information, a 2ndOTP/ID authentication requirement, a 2ndOTP/ID authentication result, a SS transaction result page, or other elements works organically to log in the SS by using the OTP login information and to support a SS's transaction by using the 2ndOTP/ID information.

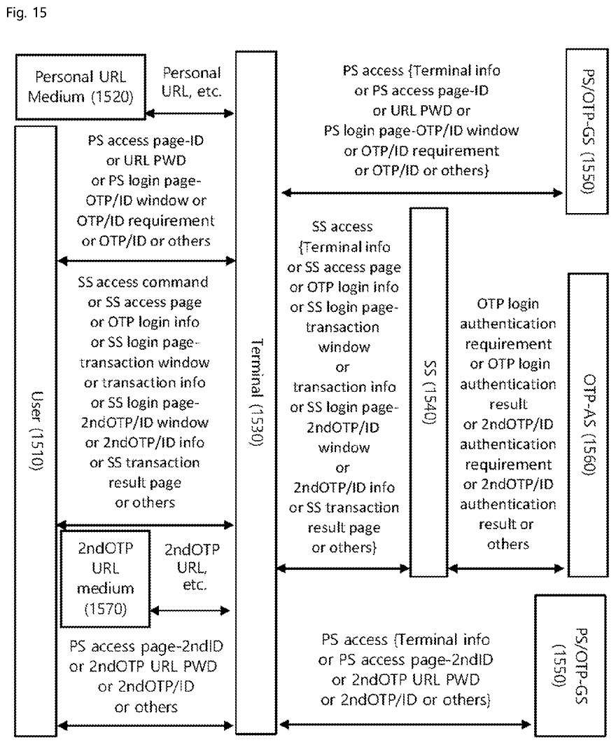

(6. Other OTP login & 2ndOTP transaction means, see FIGS. 15 to 18) A user, a personal URL medium, a terminal, a SS, a PS/OTP-GS, an OTP-AS, a 2ndOTP URL medium, a personal URL, terminal information, a PS access page-ID, a URL password, a PS login page-OTP/ID window & SS list window, an OTP/ID requirement, a SS selection, PS information, an OTP/ID, a SS access command, a SS access page, OTP login information, an OTP login authentication requirement, an OTP login authentication result, an SS login page-transaction window, transaction information, an SS login Page-2ndOTP/ID window, a 2ndOTP URL, a 2ndOTP URL password, a 2ndOTP/ID, 2ndOTP/ID information, a 2ndOTP/ID authentication requirement, a 2ndOTP/ID authentication result, a SS transaction result page, or other elements works organically to log in the SS by using the OTP login information and to support a SS's transaction by using the 2ndOTP/ID information.

a) The invention can solve duplication problems of an ID, remove the inconvenience of registering OTP user devices in all the SSs used by a user, support a global OTP service business, expand the scope of an OTP service, and support the global business of a SS.

b) The invention can support that it more safely login to a service system, and can prevent a leakage, a hacking, or an illegal use of the login information of a service system.

c) The invention can reduce the login information authentication burdens of a SS, a management burdens (the burdens managing an OTP generator, login information, transaction information, or other information), or other burdens.

d) The invention can support that an OTP is used for a login purpose.

e) The domestic OTP system of the invention can support an overseas SS.

f) The invention can economically protect an OTP algorithm, a SS, user information, and OTP system.

g) The invention can support a user management or an OTP service more safely and economically.

h) The invention can support the creation of additional profits (an advertisement profit, an aid business profit, a related business profit, a service advancement profit, or other profit). An aid business profit includes an account aid, a website aid, or other aid, a related business profit includes a delivery business, a material supply business, or other business, and a service advancement profit includes payment advancement, hall service automation, or other profits.

### BRIEF DESCRIPTION OF THE DRAWINGS

### Explanations of the Existing Drawings

FIG. 1 is the system of the JP 6032626 that an authentication server (a T-OTP-AS) supports the transaction of a SS (a BS) by authenticating an OTP generator (a T-OTP generator)'s a SN, a transaction OTP, and a transaction-linked OTP.

FIG. 2 is a method of the FIG. 1.

FIG. 3 is the system of the KR 10-1028882. A SS first checks a user by using login information (CS login information), and secondly determines a login by using the result (a user authentication result) of checking a personal identification number, an OTP generation app's SN, smart phone information, and OTP (a second authentication-ROTP). (Note: 1. ‘SN’ of a ROTP generation app SN is a unique identification number (refer to the claim 4 of the KR 10-1028882) 2. The curly brackets mean the state accessed. Note is the same as in FIG. 4)

FIG. 4 is the method of the FIG. 3.

<Explanations of the invention drawings: The curly brackets in the drawings are to help understanding of the invention by clearly indicating a connected state. It can mean a connected state even without curly brackets. The dotted lines in the drawing mean an optional step (however, FIGS. 5 and 6 are excluded)>

In order to help the overall understanding of the invention, FIG. 5 includes the OTP user ID setting system (the solid line arrows part) that a PS/OTP-GS, which can identify a user by using the personal URL of a personal URL medium, a URL password, or other information, can set an OTP user ID, the OTP login information setting system (the dotted arrows part) that a SS can deliver OTP login information to an OTP-AS and set the OTP login information by using the OTP login authentication result received from an OTP-AS, and the 2ndOTP medium registration system (the double-dotted line arrows part) that can register a 2ndOTP medium in a PS/OTP-GS, in which the PS/OTP-GS can check a user by using the personal URL of a personal URL medium, a URL password, or other information.

In order to help the overall understanding of the invention, FIG. 5 includes the OTP user ID setting method (the solid line arrows part) that the PS/OTP-GS, which can identify a user by using the personal URL of a personal URL medium, a URL password, or other information, can set an OTP user ID, the OTP login information setting method (the dotted arrows part) that a SS can deliver OTP login information to an OTP-AS and set the OTP login information by using the OTP login authentication result received from an OTP-AS, and the 2ndOTP medium registration method (the double-dotted line arrows part) that can register a 2ndOTP medium in a PS/OTP-GS, in which the PS/OTP-GS can check a user by using the personal URL of a personal URL medium, a URL password, or other information.

FIG. 7 is the OTP login system that can log in a SS by using the OTP login information including the OTP/ID generated by the PS/OTP-GS capable of identifying a user by using a personal URL, a URL password, or other information.

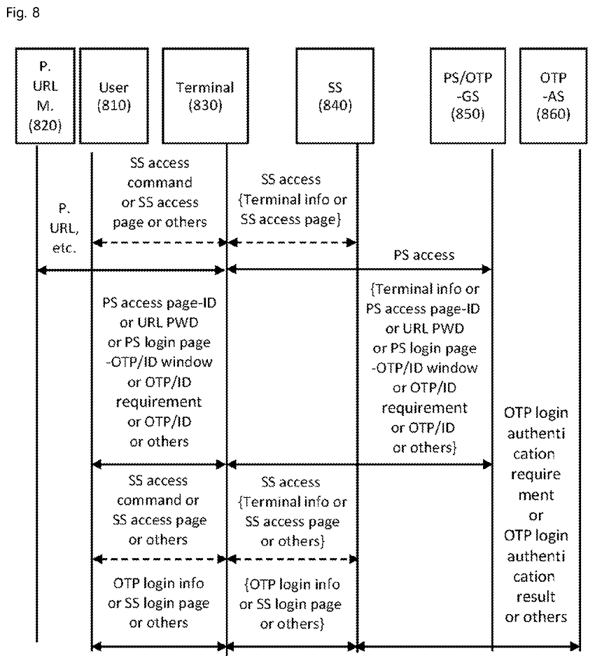

FIG. 8 is the OTP login method that can log in a SS by using the OTP login information including the OTP/ID generated by the PS/OTP-GS capable of identifying a user by using a personal URL, a URL password, or other information.

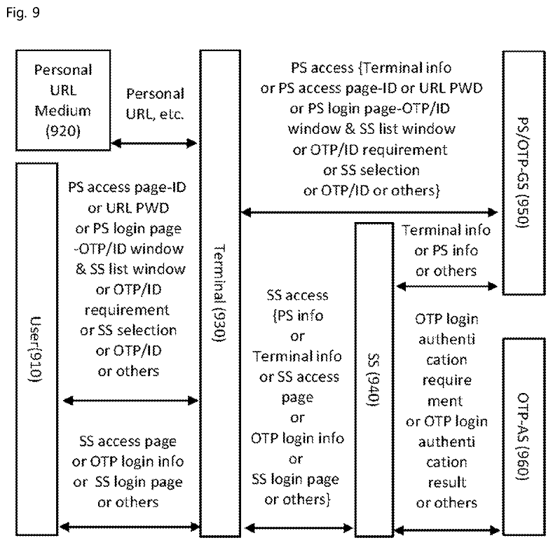

FIG. 9 is the OTP login system that can log in the SS of a SS list by using the OTP login information including the OTP/ID generated by the PS/OTP-GS capable of identifying a user by using a personal URL, a URL password, or other information.

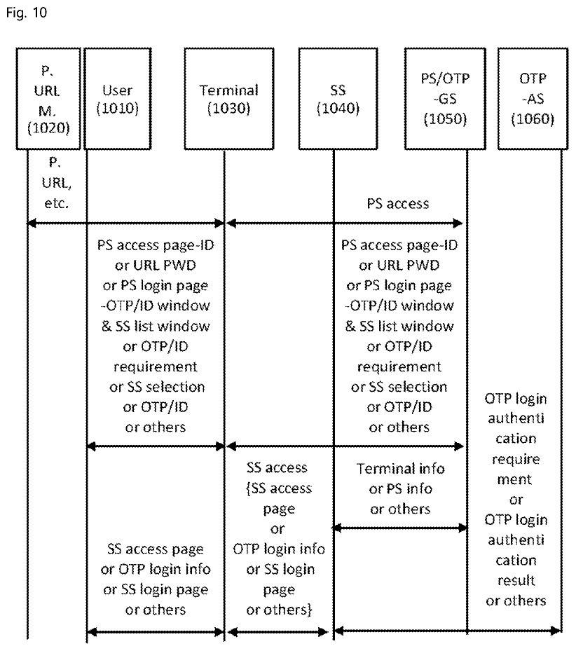

FIG. 10 is the OTP login method that can log in the SS of a SS list by using the OTP login information including the OTP/ID generated by the PS/OTP-GS capable of identifying a user by using a personal URL, a URL password, or other information.

FIG. 11 is an OTP login & 2ndOTP transaction system that can log in a SS by using the OTP login information including the OTP/ID generated by the PS/OTP-GS capable of identifying a user by using a personal URL, a URL password, or other information and support a SS's transaction by using the 2ndOTP/ID information including the 2ndOTP of a 2ndOTP generator.

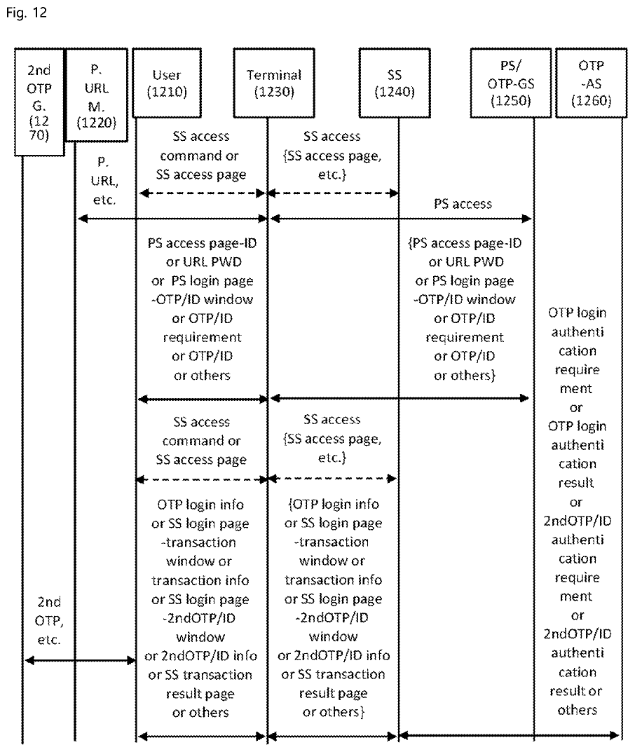

FIG. 12 is the OTP login & 2ndOTP transaction method that can log in a SS by using the OTP login information including the OTP/ID generated by the PS/OTP-GS capable of identifying a user by using a personal URL, a URL password, or other information and support a SS's transaction by using the 2ndOTP/ID information including the 2ndOTP of a 2ndOTP generator.

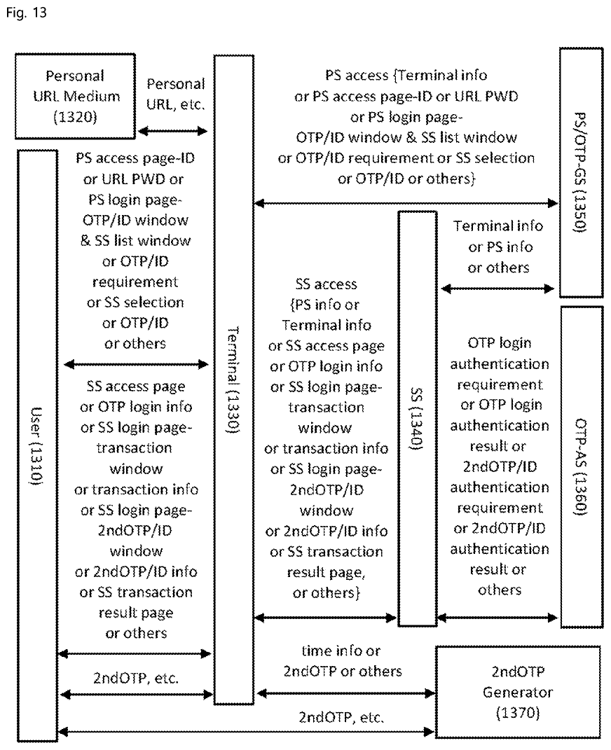

FIG. 13 is the OTP login & 2ndOTP transaction system that can log in the SS of a SS list by using the OTP login information including the OTP/ID generated by the PS/OTP-GS capable of identifying a user by using a personal URL, a URL password, or other information and support a SS's transaction by using the 2ndOTP/ID information including the 2ndOTP of a 2ndOTP generator.

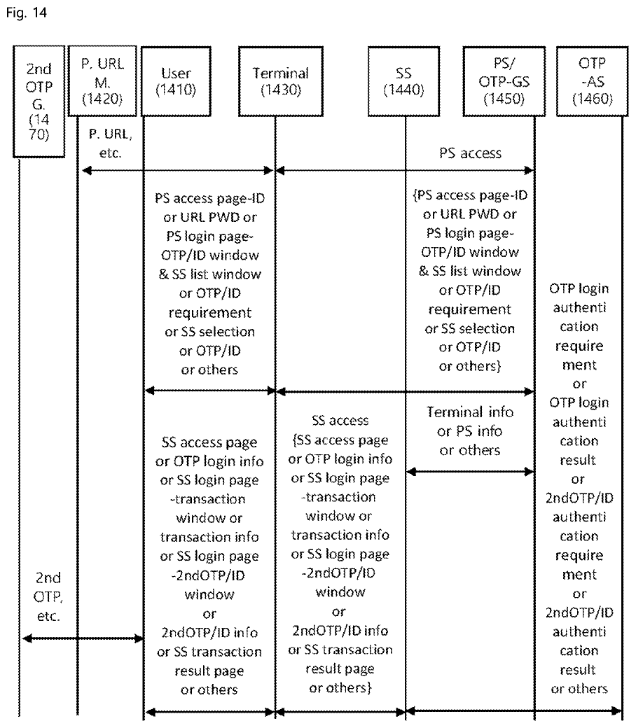

FIG. 14 is the OTP login & 2ndOTP transaction method that can log in the SS of a SS list by using the OTP login information including the OTP/ID generated by the PS/OTP-GS capable of identifying a user by using a personal URL, a URL password, or other information and support a SS's transaction by using the 2ndOTP/ID information including the 2ndOTP of a 2ndOTP generator.

FIG. 15 is the OTP login & 2ndOTP transaction system that can log in a SS by using the OTP login information including the OTP/ID generated by the PS/OTP-GS capable of identifying a user by using a personal URL, a URL password, or other information and support a SS's transaction by using the 2ndOTP/ID information including the 2ndOTP/ID generated by the PS/OTP-GS capable of identifying the user by using a 2ndOTP URL, a 2ndOTP URL password, or other information.

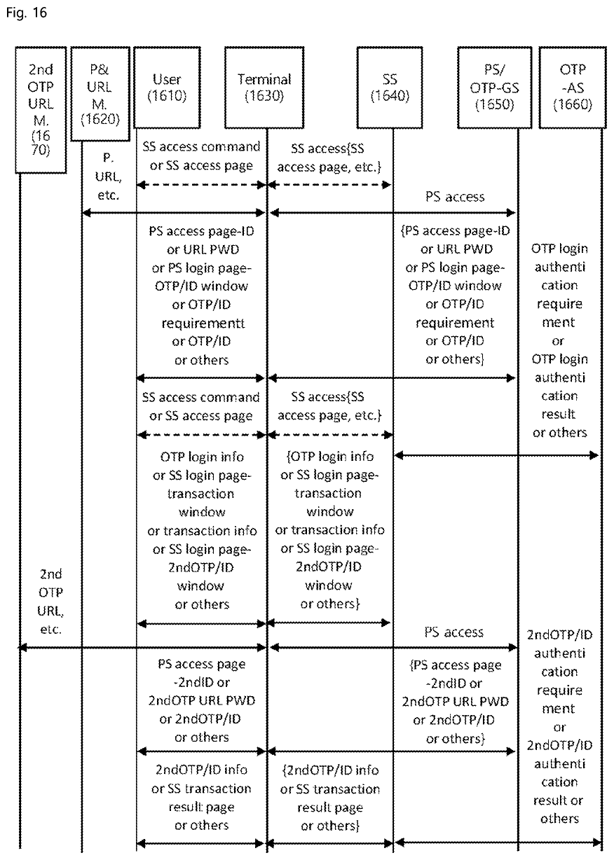

FIG. 16 is the OTP login & 2ndOTP transaction method that can log in a SS by using the OTP login information including the OTP/ID generated by the PS/OTP-GS capable of identifying a user by using a personal URL, a URL password, or other information and support a SS's transaction by using the 2ndOTP/ID information including the 2ndOTP/ID generated by the PS/OTP-GS capable of identifying the user by using a 2ndOTP URL, a 2ndOTP URL password, or other information.

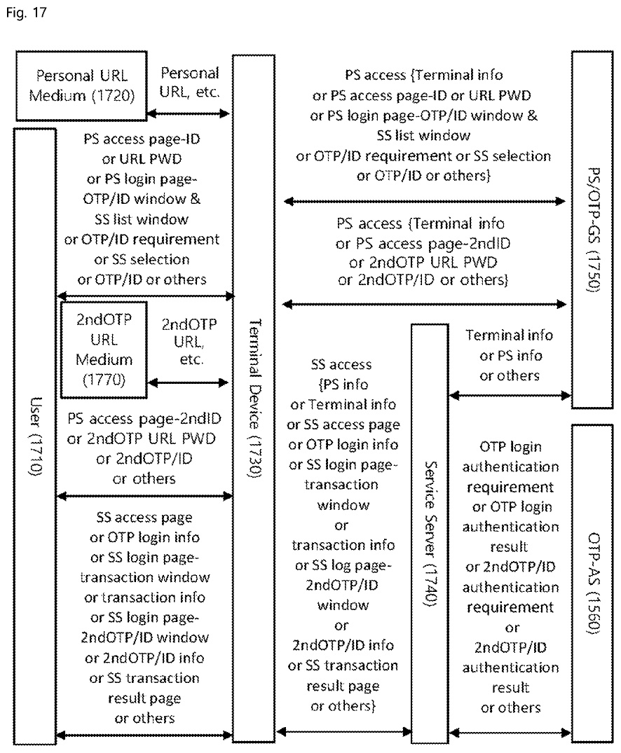

FIG. 17 is the OTP login & 2ndOTP transaction system that can log in the SS of a SS list by using the OTP login information including the OTP/ID generated by the PS/OTP-GS capable of identifying a user by using a personal URL, a URL password, or other information and support a SS's transaction by using the 2ndOTP/ID information including the 2ndOTP/ID generated by the PS/OTP-GS capable of identifying the user by using a 2ndOTP URL, a 2ndOTP URL password, or other information.

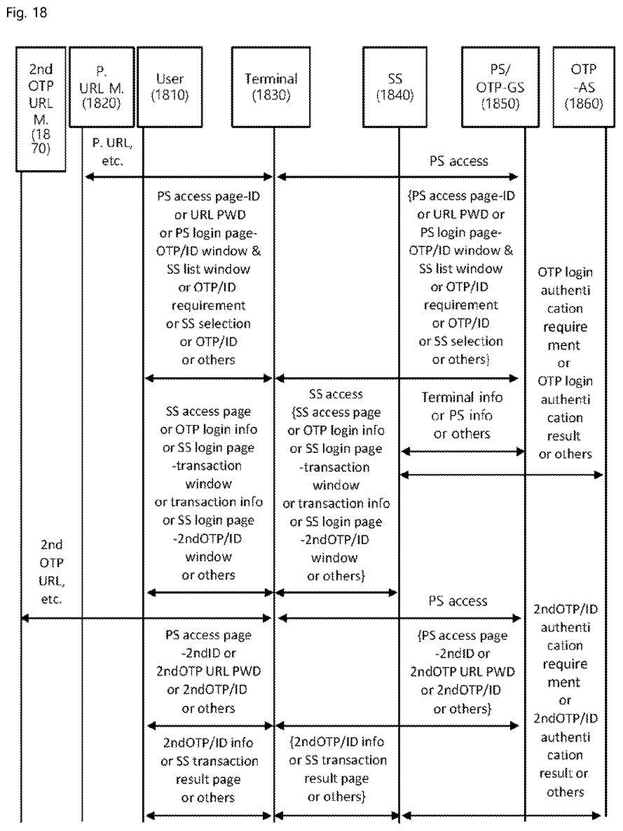

FIG. 18 is the OTP login & 2ndOTP transaction method that can log in the SS of a SS list by using the OTP login information including the OTP/ID generated by the PS/OTP-GS capable of identifying a user by using a personal URL, a URL password, or other information and support a SS's transaction by using the 2ndOTP/ID information including the 2ndOTP/ID generated by the PS/OTP-GS capable of identifying the user by using a 2ndOTP URL, a 2ndOTP URL password, or other information.

### DETAILED DESCRIPTION OF EXEMPLARY EMBODIMENTS

Hereinafter, preferred embodiments of the present invention are described in detail with reference to the accompanying drawings. The terms used herein should be interpreted not in typical or dictionary definitions but to comply in concept with the technical matters of the present invention.

The configurations disclosed in the specification and the drawings are mere examples and do not overall represent the technical spirit of the present invention. Therefore, various changes may be made thereto, and equivalents thereof also belong to the scope of the present invention.

The ‘include’ of the specification means what storing, retaining, or relating with results (setting results, operation results, communication results, or other result).

The ‘Include’ of the specification may further include other contents in addition to the contents described in the specification.

URL (Uniform Resource Locator) is to designate the type and location of a file of a server that provide the service of web documents.

RF communication (Radio Frequency Communication) is wireless communication. There is NFC communication or other wireless communication.

USB Communication is communication using the USB standard and is wired communication.

Image communication is communication using images. It can access websites by shooting QR codes.

### Definition and Explanation of Terms

(A User, a SS, an OTP system, general devices of a user) a1) A User is the subject who can use a SS, an OTP system, general devices of a user, or other devices. A user is the subject who can use an OTP service. a2) (User information) User information is the information related to a user and includes a name, a personal number (a resident registration number, the SSN, or other numbers), an addresses, a contact point, or other information. a3) (First difference from the existing user) The user of the invention does not need to remember login information of SSs. But, the existing user must remember the login information for SSs. a4) (Second difference from the existing user) The user of the present invention can solve duplication problems of a user ID by using the OTP user ID provided by an OTP system. But the existing user has duplication problems of a user ID. b) A SS is the system or the server that can support the service excluding an OTP service. c) An OTP system is the system that can support an OTP service and can include a user management system (the system managing a personal URL mediums, a PS, or other devices), an OTP-GS, an OTP-AS, OTP user devices (the devices directly used by a user to use an OTP: a 2ndOTP generator, a 2ndOTP URL medium, or other devices), or other devices. d) General devices of a user are the devices that can interwork with an OTP system, a SS, or other devices and include a terminal, etc.

(An OTP service) a) An OTP service is the service related to an OTP. b) An OTP service can include an OTP user ID setting service, an OTP login information setting service, a 2ndOTP medium registration service, an OTP login service, a 2ndOTP transaction service, an OTP login & 2ndOTP transaction service, or other service.

(An OTP/ID) a) An OTP/ID is the information capable of including an OTP, an OTP user ID, or other information. An OTP/ID can be included in OTP login information. b) An OTP/ID can be delivered through a web page, a pop-up window, a SMS, or other means.

(A 2ndOTP/ID) a) A 2ndOTP/ID is the information that include a 2ndOTP, an OTP user ID, or other information. A 2ndOTP/ID can be included in 2ndOTP/ID information. b) A 2ndOTP/ID can be delivered through a web page, a pop-up window, a SMS, or other means.

(OTP/ID refresh) (2ndOTP/ID refresh) a) OTP/ID refresh or 2ndOTP/ID refresh can regenerate an OTP/ID or a 2ndOTP/ID.

(An OTP user ID) a) An OTP user ID is the ID of the user (a subject) who can use an OTP system. b) An OTP system or a user can determine an OTP user ID and the OTP system can support the OTP/ID that can include the OTP user ID. c) An OTP user ID may be used as the ID of a user for logging in a SS. d) An OTP user ID can include a plurality of components. e) (Advantage 1) An OTP user ID is included in an OTP/ID and can eliminate a user's remembrance burden. f) (Advantage 2) An OTP user ID can eliminate duplication problems of an ID. g) (Advantage 3) An OTP user ID can eliminate the inconvenience registering devices of an OTP user in a SS. h) (Advantage 4) An OTP user ID can expand the scope of a OTP service. An OTP user ID can expand a OTP service from specific industries (banks or other industries) to general industries and support logging in a SS. i) (Advantage 5) An OTP user ID can support a global OTP service business or a global business of a SS.

(An ID duplication problem) Current users use several IDs to avoid an ID duplication problem. An OTP user ID can solve an ID duplication problem.

(OTP login information) a) OTP login information is the OTP information that can support a SS login. OTP login information can include an OTP/ID or other information. b) (An authentication subject of OTP login information) External devices (an OTP system) of a SS can authenticate OTP login information. But currently, a SS authenticates login information. c) OTP login information can be included in an OTP login authentication requirement.

(OTP information) OTP information is the information related to an OTP system or an OTP service and can include an OTP, a 2ndOTP, an OTP user ID, an OTP system ID, 2ndOTP medium information, or other information.

(An OTP system ID) a) An OTP system ID is the ID of an OTP system. b) An OTP system ID can include the information separating countries or regions, the information separating OTP systems, or other information. An OTP system ID can be included in an OTP/ID, a 2ndOTP/ID, OTP login information, 2ndOTP/ID information, or other information. c) A SS can deliver OTP login information, 2ndOTP/ID information, or other information to the external device (an OTP system) of a SS by using an OTP system ID. An OTP system ID can be used as the information connecting a SS, an OTP system, or other systems.

(A SS user ID) A SS user ID is the ID of the user (=the subject) who can use a SS. A user can use an OTP user ID as a SS user ID to solve the ID duplication problem and a SS can use an OTP user ID for a global business.

(An OTP login authentication requirement) a) An OTP login authentication requirement is what requesting an authentication of OTP login information. An OTP login authentication requirement can include OTP login information, the information of a SS, OTP usage information, or other information. b) An OTP system can authenticate OTP login information by using the information of an OTP login authentication requirement. c) An OTP system can work with a SS or other devices to support an OTP login authentication requests.

(OTP usage information) OTP usage information is the information that distinguishes the purpose of an OTP (login purpose, transaction purpose, or other purpose). A SS, an OTP system, or other devices can communicate OTP usage information with each other.

(An OTP login authentication result) An OTP login authentication result is the result of responding to an OTP log authentication request. An OTP login authentication result can include an ID (an OTP user ID or other ID), a message, or other information.

(A PS login, a SS login) a) A PS login is what logging in a PS. A SS login is what logging in a SS. b) A PS login can be determined by the first step of identifying an ID, etc. and the second step of identifying secret information, etc. In the first step, an URL (a personal URL or a 2ndOTP URL), terminal information, access path, or other elements can be used, and in the second step, a password (a URL password or a 2ndOTP URL password), a 2ndOTP, or other information can be used. A SS login can be determined by an OTP login authentication result, terminal information, PS information, or other information.

(A passage) a) (Definition) A passage is that a SS by-passes information to external devices of the SS without authenticating the information. b) In order to authenticate OTP login information, 2nd OTP/ID information, or other information, a SS can transmit them to an OTP system corresponding to an OTP system ID.

(A 2ndOTP) a) A 2ndOTP is the OTP for a transaction and can be matched with an OTP user ID. A 2ndOTP is different from the existing OTP (=transaction OTP) matching with a SN (a serial number). The ‘2nd’ of 2nd OTP is to distinguish 2ndOTP from an OTP for login purpose or the existing transaction OTP. b) A 2ndOTP can be generated by a 2ndOTP generator or a PS/OTP-GS. A 2ndOTP can be included in 2ndOTP/ID information.

(Transaction information, a transaction) Transaction information is the information (transaction details, a trader, or other information) related to a transaction. A transaction is what to exchange service, etc. and can include a transfer of funds, a payment, an exchange of information, or other exchanges. A user can deliver transaction information to a SS, etc. by using a SS login page-transaction window, etc. A SS can communicate a SS login page-2ndOTP/ID window, etc. with a user, etc. in response to transaction information.

(2ndOTP/ID information) a) 2ndOTP/ID information is the OTP information that can support a transaction. 2ndOTP/ID information can include an OTP user ID, an OTP system ID, a 2ndOTP, a 2ndOTP/ID, or other information. b) (A subject authenticating 2ndOTP/ID information) External devices (an OTP system) of a SS can authenticate 2ndOTP/ID information. c) 2ndOTP/ID information can be included in a 2ndOTP/ID authentication requirement.

(A 2ndOTP/ID authentication requirement) a) A 2ndOTP/ID authentication requirement is what requesting an authentication of 2ndOTP/ID information. A 2ndOTP/ID authentication requirement can include 2ndOTP/ID information, the information of a SS, OTP usage information, or other information. b) An OTP system can authenticate 2ndOTP/ID information by using the information of a 2ndOTP/ID authentication requirement. c) An OTP system can communicate with a SS, etc. to support a 2ndOTP/ID authentication requirement.

(A 2ndOTP/ID authentication result) A 2ndOTP/ID authentication result is the result of responding to a 2ndOTP/ID authentication requirement. A 2ndOTP/ID authentication result can include an ID, a message, or other information.

(OTP multiple authentication) An OTP multiple authentication is what authenticating the OTPs of a different purpose.

(A personal URL) a) A personal URL is a URL with an ID attribute and can include the information distinguishing a medium, an individual, a PS, or other devices. A personal URL can be matched with an OTP user ID. b) A personal URL can be stored in a personal URL medium in the form of electronic information, image information, or other information or can be encrypted. c) A personal URL can be used as login information in combination with a URL password (a password), terminal information (a terminal's ID), a 2ndOTP or other information. d) A personal URL can provide a basis for an OTP system. e) A personal URL can provide an ID while supporting a PS access. f) A personal URL can support login method using the first step of checking an ID, etc. and the second step of checking a password, etc. A personal URL can provide a basis to more securely identify a user by specifying or supporting an access route, terminal information, or other elements. g) Since a personal URL is not stored in a terminal and is included in the medium of offline, there is no risk of hacking. And since a personal URL cannot be leaked simultaneously with a URL password being remembrance information, the personal URL can provide a basis for blocking illegal login. h) A personal URL can provide a basis for blocking fraudulent login because it is used in different way from a URL password being remembrance information and combined with terminal information or other information. i) Since a personal URL support accessing a server, it can provide a basis for not storing protection information (login information, personal information, or other important information) in a terminal. j) A personal URL can support for a terminal, etc. to accesses a PS.

(A 2ndOTP URL) a) A 2ndOTP URL is the URL with an ID attribute and can support a 2ndOTP/ID. A 2ndOTP URL can include the information distinguishing a medium or a user (a subject), or other information. A 2ndOTP URL can be matched with an OTP user ID. b) A 2ndOTP URL can be included in a medium in the form of electronic information, image information, or other information and can be encrypted. c) A 2ndOTP URL can be used as information for confirming a user in combining with a 2ndOTP URL password (a password), terminal information (an ID of a terminal), or other information. d) A 2ndOTP URL can provide a basis for an OTP system. e) A 2ndOTP URL can provide an ID while supporting a PS access. f) A 2ndOTP URL can provide a basis verifying a user by using the first step of checking an ID, etc. and the second step of checking a password, etc. A 2ndOTP URL can provide a basis to more securely identify a user by specifying access route, terminal information, or other elements or supporting other functions. g) There is no risk of hacking because a 2ndOTP URL is not stored in a terminal and is stored in an offline medium. h) A 2ndOTP URL can support that a terminal or other devices connect to servers.

(A URL password, a 2ndOTP URL password) a) A URL password (URL PWD) or a 2ndOTP URL password (2ndOTP URL PWD) is the password that a user remembers. b) A URL password or a 2ndOTP URL password can be used as login information or user confirmation information in combining with a URL of a URL medium, terminal information, or other information. c) A URL password or a 2ndOTP URL password can provide a basis for logging in or verifying a user by using the first step of checking an ID, etc. and the second step of checking a password, etc. d) A URL password or a 2ndOTP URL password can provide a basis for an OTP system. e) (Advantage) A URL password or a 2ndOTP URL password is difficult to be used illegally because it is difficult to leak at the same time as a URL and must be combined with a URL medium.

(An OTP user) An OTP user is the subject using an OTP system and may be the same as a user.

(A URL medium) a) A URL medium is the medium containing a URL (a personal URL or a 2ndOTP URL), a serial number, or other information. A URL medium may be issued for each an individual (a subject), registered for each individual (a subject), or matched with an ID (an OTP user ID or other ID). A URL medium can include characteristics of a personal URL or a 2ndOTP URL and serve as an ID. b) A URL medium can provide a basis for an OTP system. c) (Type) A URL medium includes the URL RF medium supporting RF communication, the URL USB medium supporting USB communication, the URL image medium supporting image communication (shooting or other image communication), or other mediums. d) A URL medium can communicate a URL or other information with a terminal or other devices.

(Advantage of a URL medium) a) (It provides a basis for more conveniently and securely logging in a server and verifying a user) A URL medium can provide a basis for logging in or checking a user by using the first step of checking an ID, etc. and the second step of checking a password, etc. A URL medium can support a login or a user verification that can reduce actual behaviors of a user and use information with different attributes in stages. b) (Blocking fake servers or illegal use) Since a URL medium supports a PS access by electronically communicating a URL, it can fundamentally block fake servers. A URL medium can provide a basis for fundamentally blocking illegal use because it cannot be leaked simultaneously with a password (a URL password or a 2ndOTP URL password). A URL medium can provide a basis for economically blocking illegal use because it can support specifying access route, etc. or linking with terminal information, etc. c) (Blocking illegal usage) Since producing and using an illegal URL medium is not economical, a URL medium can provide a basis for fundamentally blocking a illegal usage. d) (Convenience and safe) A URL media can be manufactured in a form (a bracelet, a bioimplantable medium, or other form) that is convenient to carry for safe and convenient use. e) (Ensuring lifetime use of an OTP system) Since the loss of a URL medium has no effect on a SS, a URL medium can provide a basis for ensuring lifetime use of an OTP system.

(A personal URL medium) a) A personal URL medium is the URL medium containing a personal URL, a serial number, or other information.

(A 2ndOTP medium) a) A 2ndOTP medium is the medium containing something related to a 2ndOTP. A 2nd OTP medium can be issued for each individual (a subject), registered for each individual (a subject), or matched with an OTP user ID. b) Types of a 2ndOTP medium include a 2ndOTP generator, a 2ndOTP URL medium, or other medium. c) A 2ndOTP medium can include the function of generating a 2ndOTP, 2ndOTP medium information, a 2ndOTP URL, or other information. d) A 2ndOTP medium can communicate 2ndOTP medium information, a 2ndOTP, a 2ndOTP URL, or other information with a terminal, a user, or other devices. e) A 2nd OTP medium can be registered in an OTP system.

(2ndOTP medium information) 2ndOTP medium information is the information related to a 2ndOTP medium and includes a 2ndOTP medium's number, a 2ndOTP URL, a 2ndOTP URL password, or other information. 2ndOTP medium information can be delivered to a user, an OTP system, or other devices.

(A 2ndOTP generator) a) A 2ndOTP generator is the 2ndOTP medium capable of generating a 2ndOTP and can include other functions or information. b) A 2ndOTP generator can be registered in an OTP system and matched with an OTP user ID. c) A 2ndOTP generator can deliver a 2ndOTP or other information to a user, a terminal, or other devices.

(A 2ndOTP URL medium) a) A 2ndOTP URL medium is the URL medium containing a 2ndOTP URL or other information. b) A 2ndOTP URL medium can include features of a 2ndOTP, a URL medium, or a 2ndOTP medium. c) A 2ndOTP URL medium can support a PS access and communicate a 2ndOTP URL, etc. with a terminal, etc.

(PS/OTP-GS, personal server/OTP generation server) a) A PS/OTP-GS is the OTP system consisting of a PS (=personal server), an OTP-GS, or other devices. A PS/OTP-GS can include features of a PS or an OTP-GS. A PS/OTP-GS can include a server app (see KR 10-2020-0147427 for a server app: an OTP server app or other server apps). b) (The system containing the role of the existing OTP generator) In order to generate the password of a user, it's necessary for OTP generator to verify a user. In present, the owning an OTP generator is the verifying a user. Since the PS/OTP-GS of the present invention includes a PS capable of identifying a user, or an OTP-GS capable of generating an OTP/ID, etc. it may include the role of the existing OTP generator. c) A PS/OTP-GS can communicate a web page (a PS page, etc.), information (an OTP/ID, a 2ndOTP/ID, or other information), a pop-up windows, user information, an ID (an OTP user ID, etc.), a setting result (an OTP user ID setting result, etc.), a registration result (a 2ndOTP medium registration result, etc.), an authentication requirement (an OTP login authentication requirement, a 2ndOTP/ID authentication requirement or other authentication requirements), an authentication result (an OTP login authentication result, a 2ndOTP/ID authentication result, or other authentication results), terminal information, PS information, text messages, or other information with a terminal, an OTP-AS, or other devices. d) (Difference 1: A user verification method is different) A PS/OTP-GS is very safe because it checks a user by using offline information (a URL, etc.), a remembrance password (a URL password, a 2ndOTP URL password, or other information), terminal information, an access route, or other information. The existing OTP generator can be leaked or be hacked because it verify a user by using the fact carried by the user or online single information. e) (Difference 2: An OTP can be used for login purpose) A PS/OTP-GS can use an OTP as the login information of a SS. An OTP of the existing OTP generator cannot be used as the login information of a SS. f) (Difference 3: A ID-based OTP service can be supported) A PS/OTP-GS can support a global business because it supports an ID-based OTP service. The existing OTP generator cannot support a global business because it supports an SN-based OTP service. g) (Difference 4: An OTP multiple authentication can be supported) A PS/OTP-GS can support an OTP multiple authentications by using an OTP of a login purpose, an OTP (a 2ndOTP) of a transaction purpose, or other information. The existing OTP generator cannot support an OTP multiple authentications because it provide only an OTP of a transaction purpose. An OTP multiple authentications can almost eliminate the risks of hacking. h) (Difference 5: An OTP algorithm leakage prevention) A PS/OTP-GS can fundamentally block the leakage of an OTP algorithm because a user cannot possess it. The existing OTP generator is lost, so an OTP algorithm can be leaked. i) (Difference 6: Added values can be created) A PS/OTP-GS can create added values by using advertisements of web pages, etc. The existing OTP generator cannot create added values because it cannot use a web page.

(PS, Personal Server) A) A PS is the server assigned to an individual and can support an ID of a user. A PS can be used as the platform of an individual and can support various services (an OTP service or other services), advertisements, or other contents. b) A PS can connect to a terminal in response to a personal URL, a 2ndOTP URL, or other information, or support for a terminal to connect to a SS in response to a SS selection. c) (A PS login) A PS can determine a PS login by using a URL (a personal URL or a 2ndOTP URL), a password (a URL password or a 2ndOTP URL password), terminal information, a use way of a URL medium, an access path, a 2ndOTP, or other information. d) A PS can provide a basis for an OTP system. e) A PS can communicate information, a web page, a pop-up window with a terminal, an OTP-GS, an OTP-AS, or other devices.

(An OTP-GS, an OTP generation server) a) A OTP-GS is the server that can generate an OTP/ID, a 2ndOTP/ID, or other information, manage an ID (an OTP user ID, etc.) or information, or support an OTP service, an ancillary service (the service related to an OTP service), or other services. b) An OTP-GS can communicate information with a PS, an OTP-AS, or other devices.

(An OTP-AS, an OTP authentication server) a) An OTP-AS is the server that can authenticate an OTP, etc., manage an ID (an OTP user ID or other IDs) or information, or support an OTP service, an ancillary service, or other service. An OTP-AS can authenticate OTP login information, 2ndOTP/ID information, or other information in response to an OTP login authentication requirement, a 2ndOTP/ID authentication requirement, or other information. b) An OTP-AS can communicate user information, an ID (an OTP user ID or other IDs), a setting result, a registration result, an authentication requirement, an authentication result, a texts, or other information with a PS/OTP-GS, a SS, a terminal, or other devices.

(A terminal) a) A terminal is the device directly used by a user. A terminal can include apps (about a T-app of a server app or a terminal app, see KR 10-2020-0147427). A terminal can include other person's terminal. b) A terminal includes a smart phone, a PC, a smart phone+PC, or other devices (a smart phone+PC means that a smart phone and a PC are used simultaneously). A terminal can be composed of a plurality of devices. c) A terminal can connect to a PS in response to a URL, or connect to a SS in response to a SS access command or a SS selection of a user. d) A terminal can communicate a URL, information, a web page, a pop-up window, OTP information, or other information with a user, a URL medium, a SS, an OTP system, or other devices.

(Terminal information) a) Terminal information is the information related to a terminal, and includes an IP, an OS serial number, an International Mobile Equipment (IMEI), or other information. b) Terminal information can be delivered to a PS, a SS, or other devices. Terminal information can be used to verify a terminal's ID or a user.

(A SS: a service system or a service server) a) A SS is the system or the server capable of supporting the service excluding an OTP service. A SS can manage a SS user ID, an OTP user ID, OTP usage information, user information, or other information. b) A SS can communicate terminal information, PS information, a SS page, an OTP login authentication requirement, an OTP login authentication result, a 2ndOTP/ID authentication requirement, a 2ndOTP/ID authentication result, or other information with a terminal, an OTP system, or other devices, and it can use an OTP service. c) (Determining a SS login) A SS can determine a SS login by using an OTP login authentication result or other information. d) (Supporting a transaction) A SS can support a transaction by using transaction information, a 2ndOTP/ID authentication result, or other information. e) (Difference 1: the method determining a login is different) The SS of the present invention does not store OTP login information and determines a login by using an authentication result of OTP login information of an external device. The existing SS stores login information in itself and determines a login by authenticating login information by itself. Since the SS of the present invention does not store login information, there is no the risks of hacking, it can economically identify a user, and reduce the abuse of user information. f) (Difference 2: It can use the ID-based OTP service) The SS of the present invention can use the OTP service based on an OTP user ID. The existing SS stores the SN of an OTP generator and uses the OTP service based on the SN. The SS of the present invention can conduct a global business by using an OTP user ID. g) (Difference 3: It can use an OTP multi-authentication) The SS of the present invention can use OTPs for multiple purposes (a login usage or a transaction usage). The existing SS uses an OTP only for a transaction usage.

(SS information) SS information is the information related to a SS and includes a SS's IP, a SS's URL, or other information. SS information can be used as the ID of a SS or other information.

(An OTP user device) An OTP user device is the devices that can be used directly by a user for an OTP service.

(A SS access page)a) A SS access page is the web page supported by a SS. A SS access page includes a SS access page or a SS login page. b) A user, a terminal, a SS, or other devices can communicate a SS page with each other. c) A SS access page can include information (an OTP login information setting requirement, an OTP login information setting result, OTP login information, transaction information, 2ndOTP/ID information, or other information) or a window (an OTP login information setting window, a transaction window, a 2ndOTP/ID window, or other window), or other contents.

(An OTP login information setting requirement) An OTP login information setting requirement is what requesting the setting of OTP login information and can include information (a SS user ID, an OTP user ID, an OTP system ID, other IDs, an OTP, user information, result of texting, or other information). Information of an OTP login information setting requirement can be registered in a SS or delivered to an OTP system.

(An OTP login information setting result) An OTP login information setting result is the result corresponding to an OTP login information setting requirement and can include a message (a user's name, guidance, or other content) or other information.

(A SS access page) A SS access page is the SS page before a SS login is decided. A SS access page includes a SS access page-OTP login information setting window or other pages. A SS access page can include the window for inputting OTP login information, an OTP system selection window (the window selecting an OTP system), or other information.

(A SS access page-OTP login information setting window) A SS access page-OTP login information setting window is the SS access page that can include an OTP login information setting window (it can support the setting of OTP login information) or other information. A SS access page-OTP login information setting window can deliver an OTP login information setting requirement or other information.

(A SS login page) A SS login page is the SS page after a SS login is determined. A SS login page includes a SS login page-transaction window, a SS login page-2ndOTP/ID window, a SS transaction result page, or other pages.

(A SS login page-transaction window) A SS login page-transaction window is the SS login page capable of including a transaction window (the window capable of supporting a transaction) or other information. A SS login page-transaction window can deliver transaction information or other information.

(A SS login page-2ndOTP/ID window) A SS login page-2ndOTP/ID window is the SS login page capable of including a 2ndOTP/ID window (the window capable of supporting a 2ndOTP/ID or other information) or other information. A SS login page-2ndOTP/ID window can deliver 2ndOTP/ID information or other information.

(A SS transaction result page) A SS transaction result page is the SS page capable of including a transaction result or other information.

(A PS page) a) A PS page is the web page supported by a PS. A PS page includes a PS access page or a PS login page. b) A user, a terminal, a PS/OTP-GS, or other devices can communicate a PS page with each other. c) A PS page can include information (a ID verification result, an OTP user ID setting result, an OTP user ID setting result, a 2ndOTP medium registration result, a 2ndOTP medium registration result, an OTP/ID requirement, a SS selection, an OTP/ID, a 2ndOTP/ID, or other information), a window (the window for entering a URL password or a 2ndOTP URL password, an OTP user ID setting window, a 2ndOTP medium registration window, an OTP/ID window, an SS list window, or other windows.), or other contents.

(An OTP user ID setting requirement) An OTP user ID setting requirement is what requesting the setting of an OTP user ID. An OTP user ID setting requirement can include necessary information (a hope ID, secret assistance information, or other information) for setting an OTP user ID or can include the process setting the OTP user ID.

(An OTP user ID setting result) An OTP user ID setting result is the result corresponding to an OTP user ID setting requirement. An OTP user ID setting result can include an OTP/ID, a message, or other information.

(A 2ndOTP medium registration requirement) A 2ndOTP medium registration requirement is what requesting the registration of a 2ndOTP medium. A 2ndOTP medium registration requirement can include information (2ndOTP medium information or other information) or a process.

(A 2ndOTP medium registration result) A 2ndOTP medium registration result is the result corresponding to a 2ndOTP medium registration requirement. A 2ndOTP medium registration result can include a 2ndOTP/ID, a message, or other information.

(An OTP/ID requirement) An OTP/ID requirement is what requesting an OTP/ID. A user can deliver an OTP/ID requirement by using the method selecting an OTP/ID window or other methods. A user, a terminal, an OTP system, or other devices can communicate an OTP/ID requirement with each other.

(A SS selection) a) A SS selection is what requesting a SS access. b) A terminal can connect to a SS in response to a SS selection. And in response to the SS selection, a PS/OTP-GS can support that a terminal connects to the SS or support delivering PS information, terminal information, or other information to the SS. c) A SS can connect to a terminal in response to terminal information received from a PS/OTP-GS and can recognize PS information as a user ID. d) A SS can communicate an OTP user ID or other information with a terminal or other devices in response to the SS selection.

(A PS access page) A PS access page is the PS page before a PS login is decided. A PS access page includes a PS access page-ID, a PS access page-2ndID, or other pages.

(A PS access page-ID, A PS access page-2ndID) a) A PS access page-ID or a PS access page-2ndID is the PS access page that it has verified only ID by using a URL (a personal URL or a 2ndOTP URL), terminal information, or other information. A PS access page-ID or a PS access page-2ndID can include the window for inputting a password (a URL password, a 2ndOTP URL password, or other secret information) or include other information (a serial number of URL medium or other information).

(A PS login page) A PS login page is the PS page after a PS login is decided. A PS login page includes a PS login page-OTP user ID setting window, a PS login page-2ndOTP medium registration window, a PS login page-OTP/ID window, a PS login page-OTP/ID window & SS list window, or other pages. A PS login page can include a window, a menu, a server app, or other information.

(A PS login Page-OTP user ID setting window) A PS login page-OTP user ID-setting window is the PS login page capable of including an OTP user ID setting window (it can support the setting of an OTP user ID) or other information. A PS login page-OTP user ID setting window can deliver an OTP user ID setting requirement or other information.

(A PS login page-2ndOTP medium registration window) A PS login page-2ndOTP medium-registration window is the PS login page capable of including a 2ndOTP medium registration window (it can support the registration of a 2ndOTP medium) or other information. A PS login page-2ndOTP medium registration window can deliver a 2ndOTP medium registration requirement or other information.

(A PS login page-OTP/ID window) A PS login page-OTP/ID window is the PS login page capable of including an OTP/ID window (it can support an OTP/ID or other information) or other information. A PS login page-OTP/ID window can deliver an OTP/ID requirement or other information.

(A PS login page-OTP/ID window & SS list window) A PS login page-OTP/ID window & SS list window is the PS login page capable of including an OTP/ID window, a SS list window, or other information. A PS login page-OTP/ID window & SS list window can deliver an OTP/ID requirement, a SS selection, or other information.

(A SS list window) a) A SS list window can include or support a SS list or other information. b) The SS of a SS list can include a URL, a DN (domain name), PS information, or other information.

(PS information) PS information is the information related to a PS. PS information includes a PS's IP, a PS's URL, or other information. PS information can be used as a user ID or information to confirm a user.

(A PS access, a SS access) A PS access is what connecting to a PS and a SS access is what connecting to a SS.

(A SS access command) A SS access command is the command to access a SS.

(Time information) Time information is the information related to time, and can be used as mediation information to generate an OTP.

(Component elements of an OTP User ID) a) An OTP user ID can include an OTP system classification field, an individual classification field, a secondary password field, or other fields. b) (An OTP system classification field) An OTP system classification field is the field capable of classifying an OTP system. An OTP system classification field can include an OTP system ID or other information. An OTP system classification field can be used as the information to connect a SS, an OTP system, or other devices. c) (An individual classification field) An individual classification field is the field capable of distinguishing a user (an individual, a corporation, or other subject). An OTP system can determine an individual classification field by using a user's desired ID or other information. An OTP system can distinguish a user by using an individual classification field, a secret information field, SS information, or other information. d) (A secondary password field) A secondary password field is the field for a secondary password. A user can simply set a secondary password (e.g., two-digit numbers). A user can input a secondary password in a secondary password field.

(A secondary password) A secondary password is the password capable of assisting an OTP user ID or an OTP. A secondary password can be included in an OTP user ID or can be used separately. A user can set a secondary password by using a PS login page-OTP user ID setting window or other functions.

### Description of a System or a Method

(1. An OTP user ID setting system that can set an OTP user ID (refer to solid line arrows in FIG. 5) or an OTP login information setting system that can set OTP login information (refer to dotted arrows in FIG. 5)) A system (an OTP user ID setting system or an OTP login information setting system) that can set an OTP user ID or OTP login information, comprising: a personal URL medium that can include a personal URL, etc. or deliver a personal URL to a terminal; a terminal that can communicate a personal URL with a personal URL medium, connect to a PS/OTP-GS in response to a personal URL, communicate terminal information, a PS access page-ID, or other information with a PS/OTP-GS or a user, deliver a user's a URL password, etc. to a PS/OTP-GS, communicate a PS login page-OTP user ID setting window with a PS/OTP-GS or a user, deliver a user's an OTP user ID setting requirement to a PS/OTP-GS, deliver a PS/OTP-GS's an OTP user ID setting result to a user, connect to a SS in response to a user's a SS access command, communicate terminal information, etc. with a SS, communicate a SS access page-OTP login information setting window with a SS or a user, deliver a user's an OTP login information setting requirement to a SS, or deliver a SS's an OTP login information setting result to a user; a PS/OTP-GS that can include a PS, an OTP-GS or other devices, connect to a terminal in response to a personal URL, communicate terminal information, a PS access page-ID, or other information with a terminal, receive a URL password, etc. from a terminal, determine a PS login by using a personal URL, a URL password, or other information, communicate a PS login page-OTP user ID setting window with a terminal, receive an OTP user ID setting requirement from a terminal, or deliver an OTP user ID setting result to a terminal; an OTP-AS that can receive an OTP login authentication requirement from a SS or deliver an OTP login authentication result to a SS; a SS that can connect to a terminal, communicate terminal information, a SS access page-OTP login information setting window, or other information with a terminal, receive an OTP login information setting requirement from a terminal, deliver an OTP login authentication requirement to an OTP-AS, receive OTP login authentication result from an OTP-AS, or deliver an OTP login information setting result to a terminal; or other devices.

(2. An OTP user ID setting method that can set an OTP user ID (refer to solid line arrows in FIG. 6) or an OTP login information setting method that can set OTP login information (refer to dotted arrows in FIG. 6)) A method (an OTP user ID setting method or an OTP login information setting method) that can set an OTP user ID or OTP login information, comprising: step a) in which a terminal communicates a personal URL with a personal URL medium or connects to a PS/OTP-GS in response to a personal URL; step b) in which a PS/OTP-GS connects to a terminal in response to a personal URL or communicates terminal information, a PS access page-ID, or other information with a terminal; step c) in which a terminal delivers a PS access page-ID to a user or receives URL password, etc. from user and transmits to PS/OTP-GS; step d) in which a PS/OTP-GS determines a PS login by using a personal URL, a URL password, or other information or communicates a PS login page-OTP user ID setting window with terminal; step e) in which a terminal delivers a PS login page-OTP user ID setting window to a user or delivers a user's an OTP user ID setting requirement to a PS/OTP-GS; step f) in which a PS/OTP-GS delivers an OTP user ID setting result to a terminal; step g) in which a terminal delivers an OTP user ID setting result to a user or connects to a SS in response to a user's a SS access command: step h) in which a SS communicates terminal information, a SS access page-OTP login information setting window, or other information with a terminal; step i) in which a terminal delivers a SS access page-OTP login information setting window to a user or delivers a user's an OTP login information setting requirement to a SS; step j) in which a SS delivers an OTP login authentication requirement to an OTP-AS; step k) in which an OTP-AS delivers an OTP login authentication result to a SS; step l) in which a SS delivers an OTP login information setting result to a terminal; step m) in which a terminal delivers an OTP login information setting result to a user; or other steps.

(3. A 2ndOTP medium registration system that can register a 2ndOTP medium in a PS/OTP-GS. Refer to 2 point dash arrows in FIG. 5) An 2ndOTP medium registration system that can register a 2ndOTP media to a PS/OTP-GS, comprising: a personal URL medium that can include a personal URL, etc. or deliver a personal URL to a terminal; a 2ndOTP medium that can include 2ndOTP medium information, etc. or deliver a 2ndOTP medium information to a user; a terminal that can communicate a personal URL with a personal URL medium, connect to a PS/OTP-GS in response to a personal URL, communicate terminal information, a PS access page-ID, or other information with a PS/OTP-GS or a user, deliver a user's a URL password, etc. to a PS/OTP-GS, communicate a PS login page-2ndOTP medium registration window with a PS/OTP-GS or a user, deliver a user's a 2ndOTP medium registration requirement to a PS/OTP-GS, or deliver a PS/OTP-GS's a 2ndOTP medium registration result to a user; a PS/OTP-GS that can include a PS, an OTP-GS, or other devices, connect to a terminal in response to a personal URL, communicate terminal information, a PS access page-ID, or other information with a terminal, receive a URL password, etc. from a terminal, determine a PS login by using a personal URL, a URL password, or other information, communicate a PS login page-2ndOTP medium registration window with a terminal, receive a 2ndOTP medium registration requirement from a terminal, or deliver a 2ndOTP medium registration result to a terminal; or other devices.

(4. A 2ndOTP medium registration method that can register a 2ndOTP medium in a PS/OTP-GS. Refer to 2 point dash arrows in FIG. 6) a 2ndOTP medium registration method that can register a 2ndOTP medium in a PS/OTP-GS, comprising: step a) in which a terminal connects to a PS/OTP-GS in response to a personal URL received from a personal URL medium; step b) in which a PS/OTP-GS connects to a terminal in response to a personal URL or communicates terminal information, a PS access page-ID, or other information with a terminal; step c) in which a terminal delivers a PS access page-ID to a user or a user's a URL password, etc. to a PS/OTP-GS; step d) in which a PS/OTP-GS determines a PS login by using a personal URL, a URL password, or other information or communicates a PS login page-2ndOTP medium registration window with a terminal; step e) in which a terminal delivers a PS login page-2ndOTP medium registration window to a user; a 2ndOTP medium delivers a 2ndOTP medium information to a user; or a terminal delivers a user's a 2ndOTP medium registration requirement to a PS/OTP-GS; step f) in which a PS/OTP-GS delivers a 2ndOTP medium registration result to a terminal; step g) in which a terminal delivers a 2ndOTP medium registration result to a user; or other steps.

(5. An OTP login system that can log in to a SS by using OTP login information including an OTP/ID of a PS/OTP-GS capable of verifying a user. Refer to FIGS. 7, 9, or other information.) An OTP login system that can log in to a SS by using OTP login information including an OTP/ID generated by a PS/OTP-GS capable of verifying a user by using a personal URL, a URL password, or other information, comprising: a personal URL medium that can include a personal URL, etc. or deliver a personal URL to a terminal; a terminal that can communicate a personal URL with a personal URL medium, connect to a PS/OTP-GS in response to a personal URL, communicate terminal information, a PS access page-ID, or other information with a PS/OTP-GS or a user, deliver a user's a URL password, etc. to a PS/OTP-GS, communicate a PS login page-OTP/ID window with a PS/OTP-GS or a user, deliver a user's an OTP/ID requirement, a SS selection, or other information to a PS/OTP-GS, deliver a PS/OTP-GS's an OTP/ID, etc. to a user, connect to a SS in response to a user's a SS access command, communicate terminal information with a SS, communicate a SS access page with a SS or a user, deliver a user's OTP login information to a SS, or communicate a SS login page with a SS or a user; a PS/OTP-GS that can include a PS, an OTP-GS, or other devices, connect to a terminal in response to a personal URL, communicate terminal information, a PS access page-ID, or other information with a terminal, receive a URL password, etc. from a terminal, determine a PS login by using a personal URL, a URL password, or other information, communicate a PS login page-OTP/ID window & SS list window with a terminal, receive an OTP/ID requirement or a SS selection from a terminal, support a terminal's a SS access in response to the SS selection, or deliver an OTP/ID, etc. to a terminal; an OTP-AS that can receive an OTP login authentication requirement from a SS or deliver an OTP login authentication result to a SS; a SS that can connect to a terminal, communicate terminal information, a SS access page, or other information with a terminal, receive OTP login information from a terminal, deliver an OTP login authentication requirement to an OTP-AS, receive an OTP login authentication result from an OTP-AS, determine a SS login by using an OTP login authentication result, etc., or communicate a SS login page with a terminal; or other devices.

(6. An OTP login method that can log in to a SS by using OTP login information including an OTP/ID of a PS/OTP-GS capable of verifying a user. Refer to FIGS. 8, 10, or other information.) An OTP login method that can log in to a SS by using OTP login information including an OTP/ID generated by a PS/OTP-GS capable of verifying a user by using a personal URL, a URL password, or other information, comprising: step a) in which a terminal connects to a SS in response to a user's a SS access command and delivers a SS access page to a user or connects to a PS/OTP-GS in response to a the personal URL received from a personal URL medium; step b) in which a PS/OTP-GS connects to a terminal in response to a personal URL or communicates terminal information, a PS access page-ID, or other information with a terminal; step c) in which a terminal delivers a PS access page-ID to a user or delivers a user's a URL password, etc. to a PS/OTP-GS; step d) in which a PS/OTP-GS determines a PS login by using a personal URL, a URL password, or other information or communicates a PS login page-OTP/ID window & SS list window with a terminal; step e) in which a terminal delivers a PS login page-OTP/ID window & SS list window to a user or delivers a user's an OTP/ID requirement or a SS selection to a PS/OTP-GS; a PS/OTP-GS supports a terminal's a SS access in response to a SS selection or delivers an OTP/ID to a terminal; or a terminal delivers an OTP/ID to a user, connects to a SS in response to a user's a SS access command or a SS selection, communicates terminal information, a SS access page, or other information with a SS or a user, or delivers a user's OTP login information to a SS; step f) in which a SS delivers an OTP login authentication requirement to an OTP-AS; step g) in which an OTP-AS delivers an OTP login authentication result to a SS; step h) in which a SS determines a SS login by using an OTP login authentication result or communicates a SS login page with a terminal; step i) in which a terminal delivers a SS login page to a user; or other steps.

(7. An OTP Log & 2ndOTP transaction system that can log in to a SS by using OTP login information including an OTP/ID of a PS/OTP-GS capable of verifying a user or can support a SS's a transaction by using 2ndOTP/ID information including a 2ndOTP of a 2ndOTP generator. Refer to FIGS. 11, 13, or other information.) An OTP Log & 2ndOTP transaction system that can log in to a SS by using OTP login information including an OTP/ID generated by a PS/OTP-GS capable of verifying a user by using a personal URL, a URL password, or other information or can support a SS's a transaction by using 2ndOTP/ID information including a 2ndOTP generated by a 2ndOTP generator, comprising: a personal URL medium that can include a personal URL, etc. or deliver a personal URL to a terminal; a 2ndOTP generator that can generate a 2ndOTP or deliver a 2ndOTP to a user or a terminal; a terminal that can communicate a personal URL with a personal URL medium, connect to a PS/OTP-GS in response to a personal URL, communicate terminal information, a PS access page-ID, or other information with a PS/OTP-GS or a user, deliver a user's a URL password, etc. to a PS/OTP-GS, communicate a PS login page-OTP/ID window & SS list window with a PS/OTP-GS or a user, deliver a user's an OTP/ID requirement or a SS selection to a PS/OTP-GS, deliver a PS/OTP-GS's an OTP/ID to a user, connect to a SS in response to a user's a SS access command or a SS selection, communicate terminal information, etc. with a SS, communicate a SS access page with a SS or a user, deliver a user's OTP login information to a SS, communicate a SS login page-transaction window with a SS or a user, deliver user's transaction information to a SS, communicate a SS login page-2ndOTP/ID window with a SS or a user, deliver a 2ndOTP generator's a 2ndOTP to a user, deliver a user's 2ndOTP/ID information to a SS, or communicate a SS transaction result page with a SS or a user; a PS/OTP-GS that can include a PS, an OTP-GS, or other devices, connect to a terminal in response to a personal URL, communicate terminal information, a PS access page-ID, or other information with a terminal, receive a URL password, etc. from a terminal, determine a PS login by using a personal URL, a URL password, or other information, communicate a PS login page-OTP/ID window & SS list window with a terminal, receive an OTP/ID requirement or a SS selection from a terminal, support a terminal's a SS access in response to a SS selection, or deliver an OTP/ID to a terminal; an OTP-AS that can receive an OTP login authentication requirement from a SS, deliver an OTP login authentication result to a SS, receive a 2ndOTP/ID authentication requirement from a SS, or deliver a 2ndOTP/ID authentication result to a SS; a SS that can connect to a terminal, communicate terminal information, a SS access page, or other information with a terminal, receive OTP login information from a terminal, deliver an OTP login authentication requirement to an OTP-AS, receive an OTP login authentication result from an OTP-AS, determine a SS login by using an OTP login authentication result, communicate a SS login page-transaction window with a terminal, receive transaction information from a terminal, communicate a SS login page-2ndOTP/ID window with a terminal, receives 2ndOTP/ID information from a terminal, deliver a 2ndOTP/ID authentication requirement to an OTP-AS, receive a 2ndOTP/ID authentication result from an OTP-AS, support a transaction by using a 2ndOTP/ID authentication result, or communicate a SS transaction result page with a terminal; or other devices.

(8. An OTP Log & 2ndOTP transaction method that can log in to a SS by using OTP login information including an OTP/ID of a PS/OTP-GS capable of verifying a user or can support a SS's a transaction by using 2ndOTP/ID information including a 2ndOTP of a 2ndOTP generator. Refer to FIGS. 12, 14, or other information.) An OTP Log & 2ndOTP transaction method that can log in to a SS by using OTP login information including an OTP/ID generated by a PS/OTP-GS capable of verifying a user by using a personal URL, a URL password, or other information or can support a SS's a transaction by using 2ndOTP/ID information including a 2ndOTP generated by a 2ndOTP generator, comprising: step a) in which a terminal connects to a SS in response to a user's a SS access command and delivers a SS access page to a user or connects to a PS/OTP-GS in response to a personal URL received from a personal URL medium; step b) in which a PS/OTP-GS connects to a terminal in response to a personal URL or communicates terminal information, a PS access page-ID, or other information with a terminal; step c) in which a terminal delivers a PS access page-ID to a user or delivers a user's a URL password, etc. to a PS/OTP-GS; step d) in which a PS/OTP-GS determines a PS login by using a personal URL, a URL password, or other information or communicates a PS login page-OTP/ID window & SS list window with a terminal; step e) in which a terminal delivers a PS login page-OTP/ID window & SS list window to a user or delivers a user's an OTP/ID requirement or a SS selection to a PS/OTP-GS; a PS/OTP-GS supports a terminal's a SS access in response to a SS selection or delivers an OTP/ID to a terminal; or a terminal delivers an OTP/ID to a user, connects to a SS in response to a user's a SS access command or a SS selection, communicates terminal information, a SS access page, or other information with a SS or a user, or delivers a user's an OTP login information to a SS; step f) in which a SS delivers an OTP login authentication requirement to an OTP-AS; step g) in which an OTP-AS delivers an OTP login authentication result to a SS; step h) in which a SS determines a SS login by using an OTP login authentication result, etc. or communicates a SS login page-transaction window with a terminal; step i) in which a terminal delivers a SS login page-transaction window to a user or delivers user's transaction information to a SS; step j) in which a SS communicates a SS login page-2ndOTP/ID window with a terminal; step k) in which a terminal delivers a SS login page-2ndOTP/ID window to a user; step l) in which a 2ndOTP generator delivers a 2ndOTP to a user or a terminal; or a terminal delivers a 2ndOTP to a user or a user's 2ndOTP/ID information to a SS; step m) in which a SS delivers a 2ndOTP/ID authentication requirement to an OTP-AS step n) in which an OTP-AS delivers a 2ndOTP/ID authentication result to a SS step o) in which a SS supports a transaction by using a 2ndOTP/ID authentication result, etc. or communicates a SS transaction result page with a terminal; step p) in which a terminal delivers a SS transaction result page to a user; or other steps.

(9. An OTP Log & 2ndOTP transaction system that can log in to a SS by using OTP login information including an OTP/ID of a PS/OTP-GS capable of verifying a user or can support a SS's a transaction by using 2ndOTP/ID information including a 2ndOTP/ID of a PS/OTP-GS. Refer to FIGS. 15, 17, or other information.) An OTP Log & 2ndOTP transaction system that can log in to a SS by using OTP login information including an OTP/ID generated by a PS/OTP-GS capable of verifying a user by using a personal URL, a URL password, or other information or can support a transaction by using 2ndOTP/ID information including a 2ndOTP/ID generated by a PS/OTP-GS capable of verifying a user by using a 2ndOTP URL, a 2ndOTP URL password, or other information, comprising: a personal URL medium that can include a personal URL, etc. or deliver a personal URL to a terminal; a 2ndOTP URL medium that can include a 2ndOTP URL, etc. or deliver a 2ndOTP URL to a terminal; a terminal that can communicate a personal URL with a personal URL medium, connect to a PS/OTP-GS in response to a personal URL, communicate terminal information, a PS access page-ID, or other information with a PS/OTP-GS or a user, deliver a user's a URL password, etc. to a PS/OTP-GS, communicate a PS login page-OTP/ID window & SS list window with a PS/OTP-GS or a user, deliver a user's an OTP/ID requirement or a SS selection to a PS/OTP-GS, deliver a PS/OTP-GS's an OTP/ID to a user, connect to a SS in response to a user's a SS access command or a SS selection, communicate terminal information, etc. with a SS, communicate a SS access page with a SS or a user, deliver a user's OTP login information to a SS, communicate a SS login page-transaction window with a SS or a user, deliver a user's transaction information to a SS, communicate a SS login page-2ndOTP/ID window with a SS or a user, communicate a 2ndOTP URL with a 2ndOTP URL medium, connect to a PS/OTP-GS in response to a 2ndOTP URL, communicate terminal information, a PS access page-2ndID, or other information with a PS/OTP-GS or a user, deliver a user's a 2ndOTP URL password, etc. to a PS/OTP-GS, deliver a PS/OTP-GS's a 2ndOTP/ID to a user, deliver a user's 2ndOTP/ID information to a SS, or communicate a SS transaction result page with a SS or a user; a PS/OTP-GS that can include a PS, an OTP-GS, or other devices, connect to a terminal in response to a personal URL, communicate terminal information, a PS access page-ID, or other information with a terminal, receive a URL password, etc. from a terminal, determine a PS login by using a personal URL, a URL password, or other information, communicate a PS login page-OTP/ID window & SS list window with a terminal, receive an OTP/ID requirement or a SS selection from a terminal, support a terminal's a SS access in response to a SS selection, deliver an OTP/ID to a terminal, connect to a terminal in response to a 2ndOTP URL, communicate terminal information, a PS access page-2ndID, or other information with a terminal, receive a 2ndOTP URL password, etc. from a terminal, determine a PS login by using a 2ndOTP URL, a 2ndOTP URL password, or other information, or deliver a 2ndOTP/ID to a terminal; an OTP-AS that can receive an OTP login authentication requirement from a SS, deliver an OTP login authentication result to a SS, receive a 2ndOTP/ID authentication requirement from a SS, or deliver a 2ndOTP/ID authentication result to a SS; a SS that can connect to a terminal, communicate terminal information, a SS access page, or other information with a terminal, receive OTP login information from a terminal, deliver an OTP login authentication requirement to an OTP-AS, receive an OTP login authentication result from an OTP-AS, determine a SS login by using an OTP login authentication result, communicate a SS login page-transaction window with a terminal, receive transaction information from a terminal, communicate a SS login page-2ndOTP/ID window with a terminal, receives 2ndOTP/ID information from a terminal, deliver a 2ndOTP/ID authentication requirement to an OTP-AS, receive a 2ndOTP/ID authentication result from an OTP-AS, support a transaction by using a 2ndOTP/ID authentication result, etc., or communicate a SS transaction result page with a terminal; or other devices.

(10. An OTP Log & 2ndOTP transaction method that can log in to a SS by using OTP login information including an OTP/ID of a PS/OTP-GS capable of verifying a user or can support a SS's a transaction by using 2ndOTP/ID information including a 2ndOTP/ID of a PS/OTP-GS. Refer to FIGS. 16, 18, or other information.) An OTP Log & 2ndOTP transaction method that can log in to a SS by using OTP login information including an OTP/ID generated by a PS/OTP-GS capable of verifying a user by using a personal URL, a URL password, or other information or can support a transaction by using 2ndOTP/ID information including a 2ndOTP/ID generated by a PS/OTP-GS capable of verifying a user by using a 2ndOTP URL, a 2ndOTP URL password, or other information, comprising: step a) in which a terminal connects to a SS in response to a user's a SS access command and delivers a SS access page to a user or connects to a PS/OTP-GS in response to a personal URL received from a personal URL medium; step b) in which a PS/OTP-GS connects to a terminal in response to a personal URL or communicates terminal information, a PS access page-ID, or other information with a terminal; step c) in which a terminal delivers a PS access page-ID to a user or delivers a user's a URL password, etc. to a PS/OTP-GS; step d) in which a PS/OTP-GS determines a PS login by a personal URL, a URL password, or other information or communicates a PS login page-OTP/ID window & SS list window with a terminal; step e) in which a terminal delivers a PS login page-OTP/ID window & SS list window to a user or delivers a user's an OTP/ID requirement or a SS selection to a PS/OTP-GS; a PS/OTP-GS supports a terminal's a SS access in response to a SS selection or delivers an OTP/ID to a terminal; or a terminal delivers an OTP/ID to a user, connects to a SS in response to a user's a SS access command or a SS selection, communicates terminal information, etc. with a SS, communicates a SS access page with a SS or a user, or delivers a user's OTP login information to a SS; step f) in which a SS delivers an OTP login authentication requirement to an OTP-AS; step g) in which an OTP-AS delivers an OTP login authentication result to a SS; step h) in which a SS determines a SS login by using an OTP login authentication result, etc. or communicates a SS login page-transaction window with a terminal; step i) in which a terminal delivers a SS login page-transaction window to a user or delivers a user's transaction information to a SS; step j) in which a SS communicates a SS login page-2ndOTP/ID window with a terminal; step k) in which a terminal delivers a SS login page-2ndOTP/ID window to a user or connect to a PS/OTP-GS in response to a 2ndOTP URL of a 2ndOTP URL medium; step l) in which a PS/OTP-GS connects to a terminal in response to a 2ndOTP URL or communicates terminal information, a PS access page-2ndID, or other information with a terminal; step m) in which a terminal delivers a PS access page-2ndID to a user or delivers a user's a 2ndOTP URL password, etc. to a PS/OTP-GS; step n) in which a PS/OTP-GS determines a PS login by using a 2ndOTP URL, a 2ndOTP URL password, or other information or delivers a 2ndOTP/ID with a terminal; step o) in which a terminal delivers a 2ndOTP/ID to a user or delivers a user's a 2ndOTP/ID information to a SS; step p) in which a SS delivers a 2ndOTP/ID authentication requirement to an OTP-AS; step q) in which an OTP-AS delivers a 2ndOTP/ID authentication result to a SS; step r) in which a SS supports a transaction by using a 2ndOTP/ID authentication result, etc. or communicates a SS transaction result page with a terminal; step s) in which a terminal delivers a SS transaction result page to a user; or other steps.

### DESCRIPTION OF ELEMENTS IN EXISTING FIGURES

110,210,310,410: User
130-1,230-1, 330, 430: PC (Personal Computer)
130-2, 230-2: SP&A-App (Smart Phone & Authentication App)
172140, 240: BS (Bank Server)
340, 440: CS (Connection Server)
160, 260: T-OTP-AS (Transaction OTP-Authentication Server)
360, 460: R-OTP-AS(Response OTP-Authentication Server)
170, 270: T-OTP Generator (Transaction OTP Generator)
370, 470: SP&R-OTP-G-App (Smart Phone & Response OTP Generation App)

### DESCRIPTION OF ELEMENTS IN THE INVENTION FIGURES

510, 610, 710, 810, 910, 1010, 1110, 1210, 1310, 1410, 1510, 1610, 1710, 1810: User
520, 620, 720, 820, 920, 1020, 1120, 1220, 1320, 1420, 1520, 1620, 1720, 1820: Personal URL Medium
530, 630, 730, 830, 930, 1030, 1130, 1230, 1330, 1430, 1530, 1630, 1730, 1830: Terminal
540, 640, 740, 840, 940, 1040, 1140, 1240, 1340, 1440, 1540, 1640, 1740, 1840: SS (Service System, Service Server)
550, 650, 750, 850, 950, 1050, 1150, 1250, 1350, 1450, 1550, 1650, 1750, 1850: PS/OTP-GS (Personal Server/OTP Generation Server)
560, 660, 760, 860, 960, 1060, 1160, 1260, 1360, 1460, 1560, 1660, 1760, 1860: OTP-AS (OTP Authentication Server)
570, 670: 2ndOTP Medium
1170, 1270, 1370, 1470: 2ndOTP Generator
1570, 1670, 1770, 1870: 2ndOTP URL Medium

1. An OTP login system that can log in to a SS by using OTP login information including an OTP/ID generated by a PS/OTP-GS capable of identifying a user by using a personal URL and a URL password and/or terminal information, comprising:
a personal URL medium that can include the personal URL and deliver the personal URL to a terminal;
the terminal that can communicate the personal URL with the personal URL medium, connect to the PS/OTP-GS in response to the personal URL, communicate the terminal information with the PS/OTP-GS, communicate a PS access page-ID with the PS/OTP-GS or the user, deliver the user's the URL password to the PS/OTP-GS, communicate a PS-login page-OTP/ID window with the PS/OTP-GS or the user, deliver the user's a OTP/ID requirement to the PS/OTP-GS, deliver the PS/OTP-GS's the OTP/ID to the user, connect to the SS in response to the user's a SS access command, communicate terminal information with the SS, communicate a SS access page with the SS or the user, deliver the user's the OTP login information to the SS, and communicate a SS login page with the SS or the user;
the PS/OTP-GS that can include a PS and/or a OTP-GS, connect to the terminal in response to the personal URL, communicate the terminal information and the PS access page-ID with the terminal, receive the URL password from the terminal, determine a PS login by using the personal URL and the URL password and/or the terminal information, communicate the PS login page-OTP/ID window with the terminal, receive the OTP/ID requirement from the terminal, and deliver the OTP/ID to the terminal;
an OTP-AS that can receive an OTP login authentication requirement from the SS and deliver an OTP login authentication result to the SS; and
the SS that can connect to the terminal, communicate the terminal information and/or the SS access page with the terminal, receive the OTP login information from the terminal, deliver the OTP login authentication requirement to the OTP-AS, receive the OTP login authentication result from the OTP-AS, determine a SS login by using the OTP login authentication result, and communicate the SS login page with the terminal.

2. (canceled)

3. An OTP login system that can log in to a SS of a SS list by using OTP login information including an OTP/ID generated by a PS/OTP-GS capable of identifying a user by using a personal URL and a URL password and/or terminal information, comprising:
a personal URL medium that can include the personal URL and deliver the personal URL to a terminal;
the terminal that can communicate the personal URL with the personal URL medium, connect to the PS/OTP-GS in response to the personal URL, communicate the terminal information with the PS/OTP-GS, communicate a PS access page-ID with the PS/OTP-GS or the user, deliver the user's the URL password to the PS/OTP-GS, communicate a PS login page-OTP/ID window & SS list window with the PS/OTP-GS or the user, deliver a OTP/ID requirement and/or a SS selection of the user to the PS/OTP-GS, deliver the PS/OTP-GS's the OTP/ID to the user, connect to the SS corresponding to the SS selection, communicate terminal information with the SS, communicate a SS access page with the SS or the user, deliver the user's the OTP login information to the SS, and communicate a SS login page with the SS or the user;
the PS/OTP-GS that can include a PS and/or a OTP-GS, connect to the terminal in response to the personal URL, communicate the terminal information and/or the PS access page-ID with the terminal, receive the URL password from the terminal, determine a PS login by using the personal URL and the URL password and/or the terminal information, communicate the PS login page-OTP/ID window & SS list window with the terminal, receive the OTP/ID requirement and/or the SS selection from the terminal, and support the terminal's a SS access in response to the SS selection or deliver the OTP/ID to the terminal;
an OTP-AS that can receive an OTP login authentication requirement from the SS and deliver an OTP login authentication result to the SS; and
the SS that can connect to the terminal, communicate the terminal information and/or the SS access page with the terminal, receive the OTP login information from the terminal, deliver the OTP login authentication requirement to the OTP-AS, receive the OTP login authentication result from the OTP-AS, determine a SS login by using the OTP login authentication result, and communicate the SS login page with the terminal.

4. (canceled)

5. An OTP Login & 2ndOTP transaction system that can log in to a SS by using OTP login information including an OTP/ID generated by a PS/OTP-GS capable of identifying a user by using a personal URL and a URL password and/or terminal information and can support the SS's a transaction by using 2ndOTP/ID information including a 2ndOTP generated by a 2ndOTP generator, comprising:
a personal URL medium that can include the personal URL and deliver the personal URL to a terminal;
a 2ndOTP generator that can generate the 2ndOTP and deliver the 2ndOTP to the user or the terminal;
the terminal that can communicate the personal URL with the personal URL medium, connect to the PS/OTP-GS in response to the personal URL, communicate the terminal information with the PS/OTP-GS, communicate a PS access page-ID with the PS/OTP-GS or the user, deliver the user's the URL password to the PS/OTP-GS, communicate a PS login page-OTP/ID window with the PS/OTP-GS or the user, deliver the user's a OTP/ID requirement to the PS/OTP-GS, deliver the PS/OTP-GS's the OTP/ID to the user, connect to the SS in response to the user's a SS access command, communicate terminal information with the SS, communicate a SS access page with the SS or the user, deliver the user's the OTP login information to the SS, communicate a SS login page-transaction window with the SS or the user, deliver the user's transaction information to the SS, communicate a SS login page-2ndOTP/ID window with the SS or the user, deliver the 2ndOTP generator's the 2ndOTP to the user or deliver the user's the 2ndOTP/ID information to the SS, and communicate a SS transaction result page with the SS or the user;
the PS/OTP-GS that can include a PS and/or a OTP-GS connect to the terminal in response to the personal URL, communicate the terminal information or the PS access page-ID with the terminal, receive the URL password from the terminal, determine a PS login by using the personal URL and the URL password and/or the terminal information, communicate the PS login page-OTP/ID window with the terminal, receive the OTP/ID requirement from the terminal, and deliver the OTP/ID to the terminal;
an OTP-AS that can receive an OTP login authentication requirement from the SS, deliver an OTP login authentication result to the SS, receive a 2ndOTP/ID authentication requirement from the SS, and deliver a 2ndOTP/ID authentication result to the SS; and
the SS that can connect to the terminal, communicate the terminal information and/or the SS access page with the terminal, receive the OTP login information from the terminal, deliver the OTP login authentication requirement to the OTP-AS, receive the OTP login authentication result from the OTP-AS, determine a SS login by using the OTP login authentication result, communicate the SS login page-transaction window with the terminal, receive the transaction information from the terminal, communicate the SS login page-2ndOTP/ID window with the terminal, receives the 2ndOTP/ID information from the terminal, deliver the 2ndOTP/ID authentication requirement to the OTP-AS, receive the 2ndOTP/ID authentication result from the OTP-AS, support the transaction by using the 2ndOTP/ID authentication result, and communicate the SS transaction result page with the terminal.

6. (canceled)

7. An OTP Login & 2ndOTP transaction system that can log in to a SS of a SS list by using OTP login information including an OTP/ID generated by a PS/OTP-GS capable of identifying a user by using a personal URL and a URL password and/or terminal information and can support the SS's a transaction by using 2ndOTP/ID information including a 2ndOTP generated by a 2ndOTP generator, comprising:
a personal URL medium that can include the personal URL and deliver the personal URL to a terminal;
a 2ndOTP generator that can generate the 2ndOTP and deliver the 2ndOTP to the user or the terminal;
the terminal that can communicate the personal URL with the personal URL medium, connect to the PS/OTP-GS in response to the personal URL, communicate the terminal information with the PS/OTP-GS, communicate a PS access page-ID with the PS/OTP-GS or the user, deliver the user's the URL password to the PS/OTP-GS, communicate a PS login page-OTP/ID window & SS list window with the PS/OTP-GS or the user, deliver the user's a OTP/ID requirement and/or a SS selection to the PS/OTP-GS, deliver the PS/OTP-GS's the OTP/ID to the user, connect to the SS in response to the SS selection, communicate terminal information with the SS, communicate a SS access page with the SS or the user, deliver the user's the OTP login information to the SS, communicate a SS login page-transaction window with the SS or the user, deliver the user's transaction information to the SS, communicate a SS login page-2ndOTP/ID window with the SS or the user, deliver the 2ndOTP generator's the 2ndOTP to the user or deliver the user's the 2ndOTP/ID information to the SS, and communicate a SS transaction result page with the SS or the user;
the PS/OTP-GS that can include a PS and/or a OTP-GS connect to the terminal in response to the personal URL, communicate the terminal information and/or the PS access page-ID with the terminal, receive the URL password from the terminal, determine a PS login by using the personal URL and the URL password and/or the terminal information, communicate the PS login page-OTP/ID window & SS list window with the terminal, receive the OTP/ID requirement and/or the SS selection from the terminal, and support the terminal's a SS access or deliver the OTP/ID to the terminal;
an OTP-AS that can receive an OTP login authentication requirement from the SS, deliver an OTP login authentication result to the SS, receive a 2ndOTP/ID authentication requirement from the SS, and deliver a 2ndOTP/ID authentication result to the SS; and
the SS that can connect to the terminal, communicate the terminal information and/or the SS access page with the terminal, receive the OTP login information from the terminal, deliver the OTP login authentication requirement to the OTP-AS, receive the OTP login authentication result from the OTP-AS, determine a SS login by using the OTP login authentication result, communicate the SS login page-transaction window with the terminal, receive the transaction information from the terminal, communicate the SS login page-2ndOTP/ID window with the terminal, receives the 2ndOTP/ID information from the terminal, deliver the 2ndOTP/ID authentication requirement to the OTP-AS, receive the 2ndOTP/ID authentication result from the OTP-AS, support the transaction by using the 2ndOTP/ID authentication result, and communicate the SS transaction result page with the terminal.

8. (canceled)

9. An OTP Login & 2ndOTP transaction system that can log in to a SS by using OTP login information including an OTP/ID generated by a PS/OTP-GS capable of identifying a user by using a personal URL and a URL password and/or terminal information and can support the SS's a transaction by using 2ndOTP/ID information including a 2ndOTP/ID generated by the PS/OTP-GS capable of identifying the user by using a 2ndOTP URL and a 2ndOTP URL password and/or the terminal information, comprising:
a personal URL medium that can include the personal URL and deliver the personal URL to a terminal;
a 2ndOTP URL medium that can include the 2ndOTP URL and deliver the 2ndOTP URL to the terminal;
the terminal that can communicate the personal URL with the personal URL medium, connect to the PS/OTP-GS in response to the personal URL, communicate the terminal information with the PS/OTP-GS, communicate a PS access page-ID with the PS/OTP-GS or the user, deliver the user's the URL password to the PS/OTP-GS, communicate a PS login page-OTP/ID window with the PS/OTP-GS or the user, deliver the user's a OTP/ID requirement to the PS/OTP-GS, deliver the PS/OTP-GS's the OTP/ID to the user, connect to the SS in response to the user's a SS access command, communicate terminal information with the SS, communicate a SS access page with the SS or the user, deliver the user's the OTP login information to the SS, communicate a SS login page-transaction window with the SS or the user, deliver the user's transaction information to the SS, communicate a SS login page-2ndOTP/ID window with the SS or the user, communicate the 2ndOTP URL with the 2ndOTP URL medium, connect to the PS/OTP-GS in response to the 2ndOTP URL, communicate terminal information with the PS/OTP-GS, communicate a PS access page-2ndID with the PS/OTP-GS or the user, deliver the user's the 2ndOTP URL password to the PS/OTP-GS, deliver the PS/OTP-GS's the 2ndOTP/ID to the user, deliver the user's the 2ndOTP/ID information to the SS, and communicate a SS transaction result page with the SS or the user;
the PS/OTP-GS that can include a PS and/or a OTP-GS connect to the terminal in response to the personal URL, communicate the terminal information and/or the PS access page-ID with the terminal, receive the URL password from the terminal, determine a PS login by using the personal URL and the URL password and/or the terminal information, communicate the PS login page-OTP/ID window with the terminal, receive the OTP/ID requirement from the terminal, deliver the OTP/ID to the terminal, connect to the terminal in response to the 2ndOTP URL, communicate the terminal information and/or the PS access page-2ndID with the terminal, receive the 2ndOTP URL password from the terminal, determine a PS login by using the 2ndOTP URL and the 2ndOTP URL password and/or the terminal information, and deliver the 2ndOTP/ID to the terminal;
an OTP-AS that can receive an OTP login authentication requirement from the SS, deliver an OTP login authentication result to the SS, receive a 2ndOTP/ID authentication requirement from the SS, and deliver a 2ndOTP/ID authentication result to the SS; and
the SS that can connect to the terminal, communicate terminal information and/or the SS access page with the terminal, receive the OTP login information from the terminal, deliver the OTP login authentication requirement to the OTP-AS, receive the OTP login authentication result from the OTP-AS, determine a SS login by using the OTP login authentication result, communicate the SS login page-transaction window with the terminal, receive the transaction information from the terminal, communicate the SS login page-2ndOTP/ID window with the terminal, receives the 2ndOTP/ID information from the terminal, deliver the 2ndOTP/ID authentication requirement to the OTP-AS, receive the 2ndOTP/ID authentication result from the OTP-AS, support the transaction by using the 2ndOTP/ID authentication result, and communicate the SS transaction result page with the terminal.

10. (canceled)

11. An OTP Login & 2ndOTP transaction system that can log in to a SS of a SS list by using OTP login information including an OTP/ID generated by a PS/OTP-GS capable of identifying a user by using a personal URL and a URL password and/or terminal information and can support the SS's a transaction by using 2ndOTP/ID information including a 2ndOTP/ID generated by the PS/OTP-GS capable of identifying the user by using a 2ndOTP URL and a 2ndOTP URL password and/or the terminal information, comprising:
a personal URL medium that can include the personal URL and deliver the personal URL to a terminal;
a 2ndOTP URL medium that can include the 2ndOTP URL and deliver the 2ndOTP URL to the terminal;
the terminal that can communicate the personal URL with the personal URL medium, connect to the PS/OTP-GS in response to the personal URL, communicate the terminal information with the PS/OTP-GS, communicate a PS access page-ID with the PS/OTP-GS or the user, deliver the user's the URL password to the PS/OTP-GS, communicate a PS login page-OTP/ID window & SS list window with the PS/OTP-GS or the user, deliver the user's a OTP/ID requirement and/or a SS selection to the PS/OTP-GS, deliver the PS/OTP-GS's the OTP/ID to the user, connect to the SS in response to the SS selection, communicate terminal information with the SS, communicate a SS access page with the SS or the user, deliver the user's the OTP login information to the SS, communicate a SS login page-transaction window with the SS or the user, deliver the user's transaction information to the SS, communicate a SS login page-2ndOTP/ID window with the SS or the user, communicate the 2ndOTP URL with the 2ndOTP URL medium, connect to the PS/OTP-GS in response to the 2ndOTP URL, communicate the terminal information with the PS/OTP-GS, communicate a PS access page-2ndID with the PS/OTP-GS or the user, deliver the user's the 2ndOTP URL password to the PS/OTP-GS, deliver the PS/OTP-GS's the 2ndOTP/ID to the user, deliver the user's the 2ndOTP/ID information to the SS, and communicate a SS transaction result page with the SS or the user;
the PS/OTP-GS that can include a PS and/or a OTP-GS, connect to the terminal in response to the personal URL, communicate the terminal information or the PS access page-ID with the terminal, receive the URL password from the terminal, determine a PS login by using the personal URL and the URL password and/or the terminal information, communicate the PS login page-OTP/ID window & SS list window with the terminal, receive the OTP/ID requirement and/or the SS selection from the terminal, support the terminal's a SS access in response to the SS selection or deliver the OTP/ID to the terminal, connect to the terminal in response to the 2ndOTP URL, communicate the terminal information or the PS access page-2ndID with the terminal, receive the 2ndOTP URL password from the terminal, determine a PS login by using the 2ndOTP URL and the 2ndOTP URL password and/or the terminal information, and deliver the 2ndOTP/ID to the terminal;
an OTP-AS that can receive an OTP login authentication requirement from the SS, deliver an OTP login authentication result to the SS, receive a 2ndOTP/ID authentication requirement from the SS, and deliver a 2ndOTP/ID authentication result to the SS; and
the SS that can connect to the terminal, communicate terminal information and/or the SS access page with the terminal, receive the OTP login information from the terminal, deliver the OTP login authentication requirement to the OTP-AS, receive the OTP login authentication result from the OTP-AS, determine a SS login by using the OTP login authentication result, communicate the SS login page-transaction window with the terminal, receive the transaction information from the terminal, communicate the SS login page-2ndOTP/ID window with the terminal, receives the 2ndOTP/ID information from the terminal, deliver the 2ndOTP/ID authentication requirement to the OTP-AS, receive the 2ndOTP/ID authentication result from the OTP-AS, support the transaction by using the 2ndOTP/ID authentication result, and communicate the SS transaction result page with the terminal.

12. (canceled)
